(19) United States
(12) Patent Application Publication
(10) Pub. No.: US 2025/0030136 A1
(43) Pub. Date: Jan. 23, 2025

(54) BATTERY AND METHOD OF MANUFACTURING SAME

(71) Applicant: Panasonic Intellectual Property Management Co., Ltd., Osaka (JP)

(72) Inventors: KOICHI HIRANO, Osaka (JP); KAZUYOSHI HONDA, Osaka (JP); KAZUHIRO MORIOKA, Osaka (JP); AKIRA KAWASE, Osaka (JP)

(21) Appl. No.: 18/905,146

(22) Filed: Oct. 3, 2024

Related U.S. Application Data
(63) Continuation of application No. PCT/JP2022/040946, filed on Nov. 2, 2022.

(30) Foreign Application Priority Data
Apr. 20, 2022 (JP) 2022-069504

(51) Int. Cl. H01M 50/54; H01M 50/536

(52) U.S. Cl. CPC H01M 50/54; H01M 50/536

(57) ABSTRACT

A battery of the present disclosure includes: a power-generation element including a plurality of laminated battery cells connected electrically in parallel, each battery cell including an electrode layer, a counter-electrode layer, and a solid electrolyte layer; and a first connection member connected to a side surface of the power-generation element, the first connection member includes a first base material having a first surface facing the side surface and a first conductive member located on the first surface and electrically connected to the electrode layers, and one or more first insulating members are located so as to cover the counter-electrode layers on the side surface.

### BACKGROUND

### 1. Technical Field

The present disclosure relates to a battery and a method of manufacturing the same.

### 2. Description of the Related Art

Batteries including laminated current collectors and active substance layers have been known.

For example, Japanese Unexamined Patent Application Publications Nos. 2020-13729 and 2008-198492 disclose battery laminates including laminated unit batteries each including a positive-electrode current collector layer, a positive-electrode active substance layer, an ion-conductive inorganic substance layer, a negative-electrode active substance layer, and a negative-electrode current collector layer laminated in this order.

### SUMMARY

Increasing the capacity density of a battery requires the effective volume contributing to power generation to be improved. To achieve this, it is effective to extend the electrodes from side surfaces of the battery cells. For example, Japanese Unexamined Patent Application Publications Nos. 2020-13729 and 2008-198492 disclose batteries in which the electrodes are extended from side surfaces of the battery laminate. However, the batteries disclosed in Japanese Unexamined Patent Application Publications Nos. 2020-13729 and 2008-198492 have gaps between end portions of the laminated battery cells and hence have a problem that the capacity density of the batteries is low.

One non-limiting and exemplary embodiment provides a battery with a high capacity density and a simple manufacturing method for the battery.

In one general aspect, the techniques disclosed here feature a battery including: a power-generation element including a plurality of laminated battery cells connected electrically in parallel, each battery cell including an electrode layer, a counter-electrode layer, and a solid electrolyte layer; and a first connection member connected to a side surface of the power-generation element, in which the first connection member includes a first base material having a first surface facing the side surface and a first conductive member located on the first surface and electrically connected to the electrode layers, and one or more first insulating members are located so as to cover the counter-electrode layers on the side surface.

The present disclosure makes it possible to provide a battery with a high capacity density and a simple manufacturing method for the battery.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a battery according to Embodiment 1;

FIG. 2 is a perspective view of the battery according to Embodiment 1;

FIG. 3A is a cross-sectional view for explaining a step of a method of manufacturing the battery according to Embodiment 1;

FIG. 3B is a cross-sectional view for explaining a step of the method of manufacturing the battery according to Embodiment 1;

FIG. 3C is a cross-sectional view for explaining a step of the method of manufacturing the battery according to Embodiment 1;

FIG. 3D is a cross-sectional view for explaining a step of the method of manufacturing the battery according to Embodiment 1;

FIG. 3E is a cross-sectional view for explaining a step of the method of manufacturing the battery according to Embodiment 1;

FIG. 4 is a cross-sectional view of a battery according to Embodiment 2;

FIG. 5A is a cross-sectional view for explaining a step of a method of manufacturing a battery according to Embodiment 2;

FIG. 5B is a cross-sectional view for explaining a step of the method of manufacturing the battery according to Embodiment 2;

FIG. 5C is a cross-sectional view for explaining a step of the method of manufacturing the battery according to Embodiment 2;

FIG. 5D is a cross-sectional view for explaining a step of the method of manufacturing the battery according to Embodiment 2;

FIG. 6 is a cross-sectional view of a battery according to Embodiment 3;

FIG. 7A is a cross-sectional view for explaining a step of a method of manufacturing the battery according to Embodiment 3;

FIG. 7B is a cross-sectional view for explaining a step of the method of manufacturing the battery according to Embodiment 3;

FIG. 7C is a cross-sectional view for explaining a step of the method of manufacturing the battery according to Embodiment 3;

FIG. 7D is a cross-sectional view for explaining a step of the method of manufacturing the battery according to Embodiment 3;

FIG. 8 is a cross-sectional view for explaining a step of a method of manufacturing a battery according to Embodiment 4;

FIG. 9 is a cross-sectional view of a battery according to Embodiment 5;

FIG. 10 is a cross-sectional view of a battery according to Embodiment 6;

FIG. 11 is a cross-sectional view of a battery according to Embodiment 7;

FIG. 12 is a cross-sectional view of a battery according to Embodiment 8;

FIG. 13 is a perspective view of the battery according to Embodiment 8;

FIG. 14 is a cross-sectional view of a battery according to Embodiment 9;

FIG. 15 is a perspective view of a battery according to Embodiment 10;

FIG. 16A is a cross-sectional view of the battery according to Embodiment 10; and

FIG. 16B is a cross-sectional view of the battery according to Embodiment 10.

### DETAILED DESCRIPTIONS

### Overview of Present Disclosure

The following shows a plurality of examples of the battery according to the present disclosure.

A battery according to a first aspect of the present disclosure includes:
a power-generation element including a plurality of laminated battery cells connected electrically in parallel, each battery cell including an electrode layer, a counter-electrode layer, and a solid electrolyte layer; and
a first connection member connected to a side surface of the power-generation element,
the first connection member includes
   a first base material having a first surface facing the side surface and
   a first conductive member located on the first surface and electrically connected to the electrode layers, and
one or more first insulating members are located so as to cover the counter-electrode layers on the side surface.

Since this configuration enables the electrodes to be extended from the side surface of the power-generation element by using the first conductive member, the volume of the portion for extension can be small. This increases the volume of the portion effective for power generation relative to the entire battery and makes it possible to provide a battery with a high capacity density. In addition, since the first base material covers the side surface of the power-generation element, it is possible to provide a robust battery with high reliability.

As a second aspect of the present disclosure, for example, the battery according to the first aspect may further include
a second connection member connected to the side surface,
the second connection member may include
   a second base material having a second surface facing the side surface and
   a second conductive member located on the second surface and electrically connected to the counter-electrode layers, and
one or more second insulating members may be located so as to cover the electrode layers on the side surface.

Since this configuration enables both the electrodes and the counter electrodes to be extended from the side surface of the power-generation element by using the first conductive member and the second conductive member, the volume of the portion for extension can be smaller. This makes it possible to further improve the capacity density of the battery. In addition, since the second base material covers the side surface of the power-generation element, it is possible to provide a more robust battery with high reliability.

As a third aspect of the present disclosure, for example, the battery according to the second aspect may have a configuration in which
the side surface includes a first side surface and a second side surface different from the first side surface,
the first connection member is connected to the first side surface,
the first surface faces the first side surface,
the second connection member is connected to the second side surface, and
the second surface faces the second side surface.

Since the first side surface and the second side surface are different surfaces in this configuration, the first connection member and the second connection member can be located away from each other. Specifically, the distance between the first conductive member for extending the electrodes and the second conductive member for extending the counter electrodes can be long. This makes it possible to prevent the occurrence of a short circuit and provide a battery with high reliability.

As a fourth aspect of the present disclosure, for example, the battery according to the second aspect may have a configuration in which
the side surface includes a first side surface including a first region and a second region different from the first region,
the first connection member is connected to the first region,
the first surface faces the first region,
the second connection member is connected to the second region, and
the second surface faces the second region.

Since the first connection member and the second connection member are connected to one side surface in this configuration, it is easy to mount the battery on a circuit board or the like. Thus, it is possible to provide a battery that is easy to mount.

As a fifth aspect the present disclosure, for example, in the battery according to any one of the first to fourth aspects, the first base material may include a resin film.

Since the side surface of the power-generation element is protected by the resin film in this configuration, it is possible to provide a robust battery with high reliability. As a sixth aspect of the present disclosure, for example, in the battery according to the fifth aspect, the first base material may further include a metal layer located on a main surface of the resin film, and the first surface may be a surface of the metal layer opposite to the resin film.

Since this configuration includes the metal layer with high electrical conductivity, it is possible to achieve low resistance in the electrode extension portion.

As a seventh aspect of the present disclosure, for example, in the battery according to the sixth aspect, the metal layer may be connected to a main surface of an electrode layer located on a main surface of the power-generation element, out of the electrode layers of the plurality of battery cells.

Since this increases the contact area between the metal layer and the electrode layer, it is possible to achieve a lower resistance.

As an eighth aspect of the present disclosure, for example, in the battery according to any one of the first to fourth aspects, the first base material may be a metal foil.

Since the metal foil with high electrical conductivity is used in this configuration, it is possible to achieve low resistance in the electrode extension portion.

As a ninth aspect of the present disclosure, for example, in the battery according to the eighth aspect, the first base material may be connected to a main surface of the power-generation element.

Since this increases the contact area between the metal foil and an electrode layer or an electrode current collector layer located on the main surface of the power-generation element, it is possible to achieve a lower resistance.

As a tenth aspect of the present disclosure, for example, in the battery according to any one of the first to ninth aspects, the first base material may extend in a direction away from the side surface.

In this configuration, the extension portion of the first base material can be used for electrical connection to another device.

As an eleventh aspect of the present disclosure, for example, the battery according to the tenth aspect may further include an outer case containing the power-generation element, and the first base material may extend to the outside of the outer case.

Since the power-generation element is enclosed in the outer case in this configuration, it is possible to increase the reliability of the battery. In addition, since the extension portion of the first base material can be used for electrical connection, another member for connection is not necessary, and it is possible to improve the capacity density of the battery.

As a twelfth aspect of the present disclosure, for example, in the battery according to the third or fourth aspect, the first side surface may be flat.

Since the electrodes are extended from the flat surface, the volume of the portion for extension can be smaller. This makes it possible to further increase the capacity density of the battery.

As a thirteenth aspect of the present disclosure, for example, in the battery according to any one of the first to twelfth aspects, the first conductive member may contain a resin and conductive particles dispersed in the resin.

This configuration enables the first conductive member to be connected with high adhesiveness to the electrode layers exposed on the side surface of the power-generation element. This makes it easy to extend the electrodes from the side surface of the power-generation element.

The following shows a plurality of examples of the method of manufacturing a battery according to the present disclosure.

A method of manufacturing a battery, according to a fourteenth aspect of the present disclosure includes
connecting a connection member to a side surface of a power-generation element including a plurality of laminated battery cells connected electrically in parallel, each battery cell including an electrode layer, a counter-electrode layer, and a solid electrolyte layer,
the connection member includes
   a base material having a first surface and
   a conductive member located on the first surface, and
in the connecting the connection member, the conductive member is connected to the electrode layers such that the first surface faces the side surface, and that one or more insulating members are placed between the conductive member and the counter-electrode layers.

Since the connection member prepared separately from the power-generation element is used in this method, the manufacturing steps of the battery are simplified. Since in the battery manufactured in this method, the electrodes can be extended from the side surface of the power-generation element by using the first conductive member, the volume of the portion for extension can be small. This increases the volume of the portion effective for power generation relative to the entire battery and makes it easy to manufacture the battery with a high capacity density.

As a fifteenth aspect of the present disclosure, for example, the method of manufacturing a battery according to the fourteenth aspect may further include
forming the connection member, and
the forming the connection member may include
   placing the conductive member on the first surface and
   placing the one or more insulating members on a surface of the conductive member opposite to the base material at one or more specified positions.

Since in this method, the conductive member and the insulating members are placed on the first base material in advance, and then these are connected to the side surface of the power-generation element, it is easy to extend the electrodes. This makes it easy to manufacture a battery with a high capacity density.

As a sixteenth aspect of the present disclosure, for example, the method of manufacturing a battery according to the fourteenth aspect may further include placing the one or more insulating members on the side surface of the power-generation element so as to cover the counter-electrode layers, and the connecting the connection member may be performed after the placing the one or more insulating members.

Since the insulating members are placed on the side surface of the power-generation element in this configuration, it is possible to sufficiently cover the counter-electrode layers exposed on the side surface with the insulating members. Hence, even if a positional deviation occurs when the connection member is connected, it is possible to avoid the counter-electrode layer and the conductive member coming into contact with each other and causing a short circuit. This makes it easy to manufacture a battery with high reliability.

As a seventeenth aspect of the present disclosure, for example, in the method of manufacturing a battery according to the fifteenth or sixteenth aspect, the placing the conductive member may be performed by at least one of application or printing.

Use of application or printing in this method makes it possible to form the conductive member having accurate dimensions and an accurate position. This makes it possible to extend the electrodes from the side surface with high accuracy and thereby to manufacture a battery with a high capacity density and high reliability.

As an eighteenth aspect of the present disclosure, for example, in the method of manufacturing a battery according to any one of the fifteenth to seventeenth aspects, the placing the one or more insulating members may be performed by printing.

Use of printing in this method makes it possible to form the insulating members having accurate dimensions and accurate positions. This makes it possible to extend the electrodes from the side surface with high accuracy and thereby to manufacture a battery with a high capacity density and high reliability.

As a nineteenth aspect of the present disclosure, for example, in the method of manufacturing a battery according to any one of the fourteenth to eighteenth aspects, the base material may include a resin film or a metal foil.

Since the side surface of the power-generation element is protected by the resin film in this configuration, it is possible to manufacture a robust battery with high reliability.

As a twentieth aspect of the present disclosure, for example, the method of manufacturing a battery according to any one of the fourteenth to nineteenth aspects may further include forming the side surface including a cut surface by cutting the power-generation element in a direction intersecting a main surface of the power-generation element, and in the connecting the connection member, the connection member may be connected to the cut surface.

Since this configuration increases the flatness of the side surface of the power-generation element, it is possible to increase the capacity density of the battery. In addition, this increases electrical connectivity and electrical insulation on the side surface of the power-generation element, making it possible to manufacture a battery with high reliability.

In the following, embodiments of the present disclosure will be described specifically with reference to the drawings.

All of the following embodiments are for showing general or specific examples. Numerical values, shapes, materials, constituents, the arrangement positions and methods of connection of constituents, steps, the order of steps, and the like in the following embodiments are examples, and these are not intended to limit the present disclosure. Of the constituents in the description of the following embodiments, the constituent not stated in the independent claims are optional.

Each figure shows a schematic diagram, which is not necessarily illustrated to be precise. Hence, for example, the scale or the like in each figure is not necessarily consistent. In each figure, substantially the same constituents are denoted by the same symbols, and repetitive description is omitted or simplified.

In this specification, the terms indicating the relationship between elements such as “parallel” and “orthogonal” and the terms indicating the shapes of elements such as “rectangle” and “rectangular parallelepiped”, and the ranges of numerical values are not expressions in only a strict sense but expressions that express substantially the same or similar ranges, for example, ranges including differences of several percent or so.

In the present specification and the drawings, the x-axis, the y-axis, and the z-axis correspond to the three axes of a three-dimensional Cartesian coordinate system. In the case in which the shape of a power-generation element of a battery in plan view is rectangular, the x-axis and the y-axis correspond to the directions parallel to a first side and a second side, orthogonal to the first side, of the rectangle. The z-axis corresponds to the laminating direction of a plurality of battery cells included in a power-generation element.

In this specification, the “laminating direction” corresponds to the direction of the normal line of the main surfaces of current collectors and active substance layers. In this specification, “plan view” denotes viewing in the direction perpendicular to the main surfaces of a power-generation element, unless otherwise noted such as in the case in which the term is used alone. Note that in the case in which a phrase “plan view of a certain surface” such as “plan view of a first side surface” is stated, the certain surface refers to the “certain surface” viewed from the front.

In this specification, the terms “upper” and “lower” are not intended to indicate the upward direction (the vertically upward direction) and the downward direction (the vertically downward direction) in the absolute spatial awareness but are used as terms defined by a relative positional relationship based on the laminating order of a laminated structure. The terms “upper” and “lower” are applied to not only the case in which two constituents located away from each other, and another constituent is present between the two constituent, but also the case in which two constituents are in close contact with each other. In the following description, the negative side of the z-axis is defined as “lower” or “on the lower side”, and the positive side of the z-axis is defined as “upper” or “on the upper side”.

In this specification, the ordinal numbers such as “first” and “second” do not denote the number or the order of constituents and are used for the purpose of avoiding confusion between the same kind of constituents and distinguishing between constituents, unless otherwise noted.

### Embodiment 1

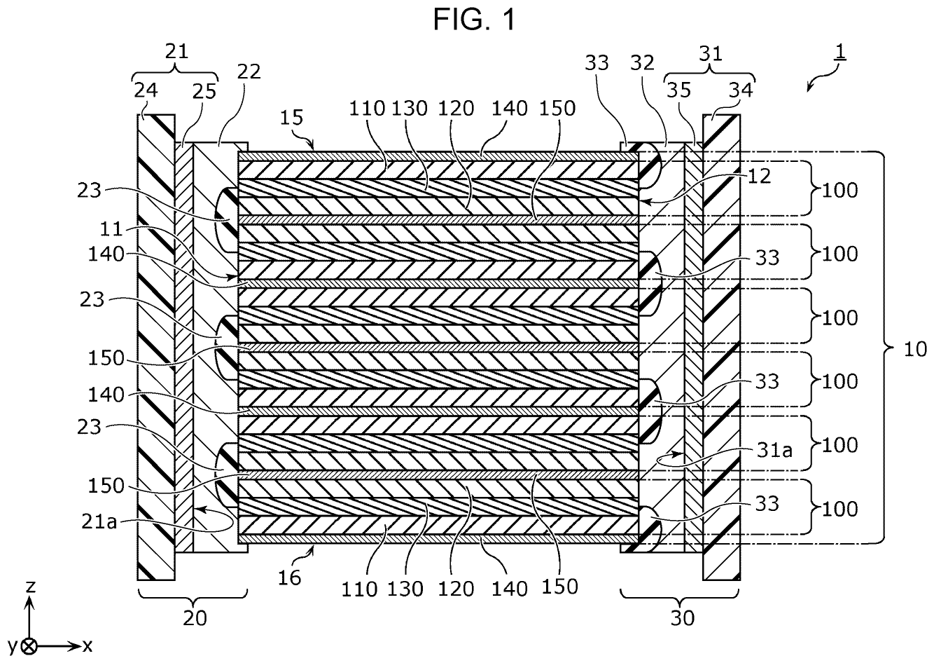

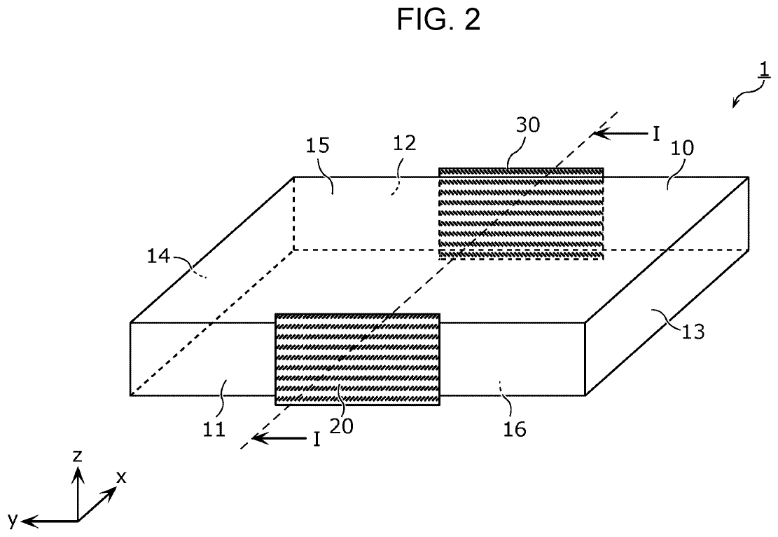

In the following, the configuration of a battery according to Embodiment 1 will be described with reference to FIGS. 1 and 2.

FIG. 1 is a cross-sectional view of a battery 1 according to the present embodiment. FIG. 1 illustrates the cross section taken along line I-I in FIG. 2. FIG. 2 is a perspective view of the battery 1 according to the present embodiment. As illustrated in FIGS. 1 and 2, the battery 1 according to the present embodiment includes a power-generation element 10, an electrode connection member 20, and a counter-electrode connection member 30. The battery 1 is, for example, an all-solid-state battery.

### [Power-Generation Element]

First, a specific configuration of the power-generation element 10 will be described.

As illustrated in FIG. 2, the power-generation element 10 has a flat rectangular parallelepiped shape. The word “flat” mentioned here denotes that the thickness (in other words, the length in the z-axis direction) is shorter than each side (in other words, the lengths in the x-axis direction and in the y-axis direction) or the maximum width of the main surfaces. The shape of the power-generation element 10 in plan view is not limited to a rectangle and may be another polygon such as a square, a hexagon, or an octagon, or a circular or elliptical shape.

As illustrated in FIGS. 1 and 2, the power-generation element 10 includes the main surfaces 15 and 16 and the side surfaces. The side surfaces include the four side surfaces 11, 12, 13, and 14. In the present embodiment, each of the side surfaces 11, 12, 13, and 14 and the main surfaces 15 and 16 is flat.

The side surface 11 is an example of a first side surface, and the electrode connection member 20 is connected to the side surface 11. The side surface 12 is an example of a second side surface, which differs from the first side surface, and the counter-electrode connection member 30 is connected to the side surface 12. The side surface 12 is opposite to the side surface 11. The side surfaces 11 and 12 are, for example, cut surfaces. The side surfaces 13 and 14 are opposed to each other, and each of the side surfaces 13 and 14 is orthogonal to the side surfaces 11 and 12.

The main surfaces 15 and 16 are opposed to each other, and each of the main surfaces 15 and 16 is orthogonal to the side surfaces 11, 12, 13, and 14. The main surface 15 is the uppermost surface of the power-generation element 10. The main surface 16 is the lowermost surface of the power-generation element 10.

As illustrated in FIG. 1, the power-generation element 10 includes a plurality of battery cells 100, a plurality of electrode current collector layers 140, and a plurality of counter-electrode current collector layers 150. Note that in the illustration in FIG. 1 and other cross-sectional views, the thickness of each layer is exaggerated to facilitate understanding of the layer structure of the power-generation element 10.

The battery cell 100 is a battery of a smallest configuration and is hence also referred to as a unit cell. The plurality of battery cells 100 are connected electrically in parallel and laminated. In the present embodiment, all of the battery cells 100 of the power-generation element 10 are connected electrically in parallel.

Each of the battery cells 100 includes an electrode layer 110, a counter-electrode layer 120, and a solid electrolyte layer 130. The solid electrolyte layer 130 is located between the electrode layer 110 and the counter-electrode layer 120.

With attention focused on two adjacent battery cells 100 of the plurality of battery cells 100, the laminating order of the layers included in each of the two battery cells is opposite. For example, in the battery cell 100 in the lowermost layer, the electrode layer 110, the solid electrolyte layer 130, and the counter-electrode layer 120 are laminated in this order from bottom to top. In contrast, in the second battery cell 100 from the bottom, the counter-electrode layer 120, the solid electrolyte layer 130, and the electrode layer 110 are laminated in this order from bottom to top. In other words, in these two battery cells 100, the counter-electrode layers 120 of the two battery cells 100 face each other with a counter-electrode current collector layer 150 located in between.

The plurality of battery cells 100 are laminated such that the laminating order of the layers alternates for each battery cell. Hence, for example, in the second and third battery cells 100 from the bottom, the electrode layers 110 of the two battery cells 100 face each other with an electrode current collector layer 140 located in between. In this configuration, an electrode current collector layer 140 and a counter-electrode current collector layer 150 alternate in the z-axis direction.

In the present embodiment, the electrode layer 110 is, for example, a positive electrode layer, and the counter-electrode layer 120 is, for example, a negative electrode layer. The electrode current collector layer 140 is, for example, a positive-electrode current collector layer, and the counter-electrode current collector layer 150 is, for example, a negative-electrode current collector layer.

The electrode layer 110 is located between the electrode current collector layer 140 and the solid electrolyte layer 130. Note that another layer such as a conductive joining layer may be provided between the electrode layer 110 and the electrode current collector layer 140.

The electrode layer 110 is, for example, a positive-electrode active substance layer containing a positive electrode material such as a positive-electrode active substance. For the material of the positive-electrode active substance, various materials that metal ions such as lithium ions and magnesium ions can be detached from and inserted into can be used. For the positive-electrode active substance that lithium ions can be detached from and inserted into, for example, lithium-cobalt composite oxide (LCO), lithium-nickel composite oxide (LNO), lithium-manganese composite oxide (LMO), lithium-manganese-nickel composite oxide (LMNO), lithium-manganese-cobalt composite oxide (LMCO), lithium-nickel-cobalt composite oxide (LNCO), lithium-nickel-manganese-cobalt composite oxide (LNMCO), and lithium-nickel-cobalt-aluminum composite oxide (LNCAO) can be used.

The constituent material of the electrode layer 110 may include, for example, a solid electrolyte such as an inorganic solid electrolyte. Examples of inorganic solid electrolytes that can be used include a sulfide solid electrolyte and an oxide solid electrolyte. Examples of sulfide solid electrolytes that can be used include a mixture of lithium sulfide (Li₂S) and diphosphorus pentasulfide (P₂S₅). Examples of sulfide solid electrolytes that can be used include sulfides such as Li₂S—SiS₂, Li₂S—B₂S₃, and Li₂S—GeS₂, and these sulfides containing at least one selected from the group of Li₃N, LiCl, LiBr, Li₃PO₄, and Li₄SiO₄ as an additive can also be used.

Examples of oxide solid electrolytes that are used include Li₇La₃Zr₂O₁₂ (LLZ), Li_{1.3}Al_{0.3}Ti_{1.7}(PO₄)₃ (LATP), and (La,Li)TiO₃ (LLTO). The surface of the positive-electrode active substance may be coated with a solid electrolyte.

The constituent material of the electrode layer 110 may include, for example, at least one of a conductive material such as acetylene black, Ketjenblack (registered trademark), and carbon nanofiber, or a binder such as polyvinylidene fluoride.

The thickness of the electrode layer 110 is, for example, greater than or equal to 5 μm and less than or equal to 300 μm but is not limited to this range.

The counter-electrode layer 120 is located between the counter-electrode current collector layer 150 and the solid electrolyte layer 130. The counter-electrode layer 120 faces the electrode layer 110 with the solid electrolyte layer 130 interposed in between. Note that another layer such as a conductive joining layer may be provided between the counter-electrode layer 120 and the counter-electrode current collector layer 150.

The counter-electrode layer 120 is, for example, a negative-electrode active substance layer containing a negative-electrode active substance as an electrode material. For the negative-electrode active substance, various materials that ions such as lithium ions and magnesium ions can be detached from and inserted into can be used. As for the negative-electrode active substances that can be used for the constituent substances of the counter-electrode layer 120, examples of the negative-electrode active substances that lithium ions can be detached from and inserted into include a simple substance such as graphite, metallic lithium, or silicon, and a mixture of some of them, or lithium-titanium oxide (LTO).

For the constituent material of the counter-electrode layer 120, for example, a solid electrolyte such as an inorganic solid electrolyte can be used. Examples of inorganic solid electrolytes that can be used include the inorganic solid electrolytes shown as examples of the constituent material of the electrode layer 110.

The constituent material of the counter-electrode layer 120 may include, for example, at least one of a conductive material such as acetylene black, Ketjenblack, and carbon nanofiber, or a binder such as polyvinylidene fluoride.

The thickness of the counter-electrode layer 120 is, for example, greater than or equal to 5 μm and less than or equal to 300 μm but is not limited to this range.

The solid electrolyte layer 130 is located between the electrode layer 110 and the counter-electrode layer 120. The solid electrolyte layer 130 is in contact with both the electrode layer 110 and the counter-electrode layer 120.

The solid electrolyte layer 130 contains a solid electrolyte. Examples of solid electrolytes that can be used include an inorganic solid electrolyte. Examples of the inorganic solid electrolytes that can be used include the inorganic solid electrolytes shown as examples of the constituent material of the electrode layer 110.

Note that the solid electrolyte layer 130 may contain, in addition to an electrolyte material, a binder or the like such as polyvinylidene fluoride, for example.

The thickness of the solid electrolyte layer 130 is, for example, greater than or equal to 5 μm and less than or equal to 300 μm but is not limited to this range. The thickness of the solid electrolyte layer 130 may be, for example, greater than or equal to 5 μm and less than or equal to 100 μm.

A main surface of the electrode current collector layer 140 is in contact with an electrode layer 110. As for an electrode current collector layer 140 located between two battery cells 100, of the plurality of electrode current collector layers 140, each of the two main surfaces is in contact with an electrode layer 110. As for the electrode current collector layer 140 in the uppermost or lowermost layer, only one of the two main surfaces is in contact with an electrode layer 110. Specifically, the lower surface of the electrode current collector layer 140 in the uppermost layer is in contact with an electrode layer 110, and the upper surface of the electrode current collector layer 140 in the uppermost layer is the main surface 15 of the power-generation element 10. The upper surface of the electrode current collector layer 140 in the lowermost layer is in contact with an electrode layer 110, and the lower surface of the electrode current collector layer 140 in the lowermost layer is the main surface 16 of the power-generation element 10. Note that the electrode current collector layer 140 may include a current collector layer provided where the electrode current collector layer 140 is in contact with the electrode layer 110 and containing a conductive material.

A main surface of the counter-electrode current collector layer 150 is in contact with a counter-electrode layer 120. As for a counter-electrode current collector layer 150 located between two battery cells 100, of the plurality of counter-electrode current collector layers 150, each of the two main surfaces is in contact with a counter-electrode layer 120. Note that the counter-electrode current collector layer 150 may include a current collector layer provided where the counter-electrode current collector layer 150 is in contact with the counter-electrode layer 120 and containing a conductive material.

Each of the electrode current collector layer 140 and the counter-electrode current collector layer 150 is a conductive member having a foil shape, a plate shape, or a mesh shape. Each of the electrode current collector layer 140 and the counter-electrode current collector layer 150 may be, for example, a thin conductive film. Examples of materials that can be used for the electrode current collector layer 140 and the counter-electrode current collector layer 150 include metals such as stainless steel (SUS (a symbol in Japan Industrial Standards)), aluminum (Al), copper (Cu), and nickel (Ni). The electrode current collector layer 140 and the counter-electrode current collector layer 150 may be formed of different materials.

The thickness of each of the electrode current collector layer 140 and the counter-electrode current collector layer 150 is, for example, greater than or equal to 5 μm and less than or equal to 100 μm but is not limited to this range.

### [Electrode Connection Member]

Next, the electrode connection member 20 will be described.

The electrode connection member 20 is an example of a first connection member and is connected to the side surface 11 of the power-generation element 10. As illustrated in FIG. 1, the electrode connection member 20 includes a base material 21, a conductive member 22, and insulating members 23.

The base material 21 is an example of a first base material and has a surface 21a facing the side surface 11. The surface 21a is an example of a first surface. The base material 21 includes a resin film 24 and a metal layer 25.

The resin film 24 serves as a support member for the metal layer 25. The metal layer 25 is in contact with a main surface of the resin film 24.

For the resin film 24, for example, a material having an electrical insulating property, heat resistance, and smoothness can be used. Examples of materials that can be used for the resin film 24 include polyimide, polyethylene terephthalate (PET), polyethylene naphthalate (PEN), polyetheretherketone (PEEK), polyamide, polyester, polyphenylene sulfide (PPS), polyphenylene ether (PPE), and polycarbonate (PC).

The thickness of the resin film 24 is, for example, greater than or equal to 5 μm and less than or equal to 300 μm but is not limited to this range. A thicker resin film 24 enables the strength of the resin film 24 to be kept larger than or equal to a certain degree, increasing the robustness of the battery 1. In contrast, a thinner resin film 24 increases the flexibility and the handling properties of the resin film 24. In addition, it is possible to mitigate a decrease in the capacity density of the battery 1.

The metal layer 25 is located on a main surface of the resin film 24. The surface of the metal layer 25 opposite to the resin film 24 is the surface 21a of the base material 21.

For the constituent material of the metal layer 25, a material having a high electrical conductivity can be used. For example, the metal layer 25 contains, copper, silver, gold, platinum, palladium, nickel, aluminum, iron, cobalt, zinc, or an alloy of two or more of these.

The thickness of the metal layer 25 is, for example, greater than or equal to 3 μm and less than or equal to 100 μm but is not limited to this range. A thicker metal layer 25 reduces the electrical resistance of the metal layer 25. In contrast, a thinner metal layer 25 mitigates a decrease in the capacity density of the battery 1.

In the example illustrated in FIG. 1, the length of the base material 21 in the z-axis direction is longer than the thickness of the power-generation element 10 but is not limited to this configuration. The length of the base material 21 in the z-axis direction may be equal to the thickness of the power-generation element 10 or may be shorter than the thickness of the power-generation element 10.

The conductive member 22 is an example of a first conductive member and is located on the surface 21a of the base material 21. The conductive member 22 is electrically connected to the electrode layers 110 of the power-generation element 10, on the side surface 11. Specifically, the conductive member 22 is in contact with the end surfaces of all of the electrode layers 110 included in the power-generation element 10, on the side surface 11. The conductive member 22 is also in contact with the end surfaces of the electrode current collector layers 140 on the side surface 11. In the present embodiment, the conductive member 22 is in contact with main surfaces of electrode current collector layers 140, on the main surfaces 15 and 16.

The conductive member 22 is not in contact with the counter-electrode layers 120 or the counter-electrode current collector layers 150 included in the power-generation element 10. This configuration prevents the occurrence of a short circuit between the positive and negative sides of the power-generation element 10. Specifically, on the side surface 11, the insulating members 23 are located between the conductive member 22 and the counter-electrode layers 120 and counter-electrode current collector layers 150. Note that the conductive member 22 may be in contact with the end surface of a solid electrolyte layer 130, on the side surface 11.

The conductive member 22 is a conductive resin composite containing a resin and conductive particles dispersed in the resin. Examples of conductive particles that can be used include silver, copper, nickel, gold, and an alloy of some of these. Examples of resins that can be used include an epoxy resin, a phenolic resin, an acrylic resin, a methacrylic resin, a silicone resin, an aramid resin, a polyimide resin, and a urethane resin.

Each insulating member 23 is an example of a first insulating member. The insulating members 23 are located so as to cover the counter-electrode layers 120 on the side surface 11. Specifically, the insulating members 23 are located between the conductive member 22 and the counter-electrode layers 120. More specifically, the insulating members 23 are in contact with and cover, on the side surface 11, the entire end surfaces of the counter-electrode layers 120 and the counter-electrode current collector layers 150 included in the power-generation element 10. The insulating members 23 are in contact with and cover the end surfaces of the solid electrolyte layers 130 on the side surface 11. Note that the insulating members 23 need not cover the end surfaces of the solid electrolyte layers 130 on the side surface 11. The insulating members 23 may cover the entire end surfaces of the solid electrolyte layers 130 on the side surface 11 and may cover part of the end surfaces of the electrode layers 110 on the side surface 11. The insulating members 23 have, for example, a striped shape in which each stripe extends along the end surfaces of the corresponding counter-electrode layers 120 and counter-electrode current collector layer 150 in plan view of the side surface 11.

The insulating member 23 is electrically insulating. For example, for the constituent substances of the insulating member 23, substances having an electrical insulating property and an adhesiveness can be used. Specifically, for the insulating member 23, for example, insulating resins such as an epoxy resin, a phenolic resin, a silicone resin, polyurethane, and an acrylic resin can be used. The insulating member 23 may contain insulating inorganic filler dispersed in the resin mentioned above. Examples of inorganic filler that can be used include talc, silica, alumina, glass, mica, barium sulfate, and titanium oxide. The size of a piece of inorganic filler is, for example, larger than or equal to 0.01 μm and smaller than or equal to 10 μm but is not limited to this range.

Note that the insulating member 23 may be in contact with the metal layer 25. In this case, the conductive member 22 may be divided by the insulating members 23 with a stripe shape. The divided conductive members 22 are electrically connected via the metal layer 25.

### [Counter-Electrode Connection Member]

Next, the counter-electrode connection member 30 will be described.

The counter-electrode connection member 30 is an example of a second connection member and is connected to the side surface 12 of the power-generation element 10. As illustrated in FIG. 1, the counter-electrode connection member 30 includes a base material 31, a conductive member 32, and insulating members 33.

The base material 31 is an example of a second base material and has a surface 31a facing the side surface 12. The surface 31a is an example of a second surface. The base material 31 includes a resin film 34 and a metal layer 35.

The resin film 34 serves as a support member for the metal layer 35. The metal layer 35 is in contact with a main surface of the resin film 34.

The resin film 34 can be composed of, for example, the same material that can be used for the resin film 24. The thickness of the resin film 34 is, for example, greater than or equal to 5 μm and less than or equal to 300 μm. The resin film 34 with this configuration provides the effects the same as or similar to those of the resin film 24. The thickness of the resin film 34 is not limited to this range.

The metal layer 35 is located on a main surface of the resin film 34. The surface of the metal layer 35 opposite to the resin film 34 is the surface 31a of the base material 31.

For the constituent material of the metal layer 35, the same material that can be used for the constituent material of the metal layer 25 can be used. The thickness of the metal layer 35 is, for example, greater than or equal to 3 μm and less than or equal to 100 μm. The metal layer 35 with this configuration provides the effects the same as or similar to those of the metal layer 25. Note that the thickness of the metal layer 35 is not limited to this range.

In the example illustrated in FIG. 1, the length of the base material 31 in the z-axis direction is longer than the thickness of the power-generation element 10 but is not limited to this configuration. The length of the base material 31 in the z-axis direction may be equal to the thickness of the power-generation element 10 or may be shorter than the thickness of the power-generation element 10.

The conductive member 32 is an example of a second conductive member and is located on the surface 31a of the base material 31. The conductive member 32 is electrically connected to the counter-electrode layers 120 of the power-generation element 10, on the side surface 12. Specifically, the conductive member 32 is in contact with the end surfaces of all of the counter-electrode layers 120 included in the power-generation element 10, on the side surface 12. The conductive member 32 is also in contact with the end surfaces of the counter-electrode current collector layers 150 on the side surface 12.

The conductive member 32 is not in contact with the electrode layers 110 or the electrode current collector layers 140 included in the power-generation element 10. This configuration prevents the occurrence of a short circuit between the positive and negative sides of the power-generation element 10. Specifically, on the side surface 12, the insulating members 33 are located between the conductive member 32 and the electrode layers 110 and electrode current collector layers 140. Note that the conductive member 32 may be in contact with the end surface of a solid electrolyte layer 130, on the side surface 12.

The conductive member 32 is a conductive resin composite containing a resin and conductive particles dispersed in the resin. For the conductive particles and the resin, the same material that can be used for the conductive member 22 can be used.

Each insulating member 33 is an example of a second insulating member. The insulating members 33 are located so as to the cover electrode layers 110 on the side surface 12. Specifically, the insulating members 33 are located between the conductive member 32 and the electrode layers 110. Specifically, the insulating members 33 are in contact with and cover, on the side surface 12, the entire end surfaces of the electrode layers 110 and the electrode current collector layers 140 included in the power-generation element 10. The insulating members 33 are in contact with and cover the end surfaces of the solid electrolyte layers 130 on the side surface 12. Note that the insulating members 33 need not cover the end surfaces of the solid electrolyte layers 130 on the side surface 12. The insulating members 33 may cover the entire end surfaces of the solid electrolyte layers 130 on the side surface 12 and may cover part of the end surfaces of the counter-electrode layers 120 on the side surface 12. The insulating members 33 have, for example, a striped shape in which each stripe extends along the end surfaces of the corresponding electrode layers 110 and electrode current collector layer 140 in plan view of the side surface 12.

The insulating member 33 is electrically insulating. For the constituent substances of the insulating member 33, for example, the same material that can be used for the insulating member 23 can be used. For example, the insulating member 33 may contain insulating inorganic filler dispersed in the resin mentioned above.

Note that the insulating member 33 may be in contact with the metal layer 35. In this case, the conductive member 32 may be divided by the insulating members 33 of a stripe shape. The divided conductive members 32 are electrically connected via the metal layer 35.

In the present embodiment, the conductive member 32 electrically connects the counter-electrode layers 120 of the plurality of battery cells 100, and the conductive member 22 electrically connects the electrode layers 110 of the plurality of battery cells 100. This configuration enables the plurality of battery cells 100 to be connected in parallel. This connection can be achieved in only small portions in close contact with the side surfaces 11 and 12 of the power-generation element 10, increasing the capacity density of the battery 1.

Note that the electrode layer 110 and the electrode current collector layer 140 can be considered to be at the same electric potential. The counter-electrode layer 120 and the counter-electrode current collector layer 150 can be considered to be at the same electric potential. Hence, from an electrical viewpoint, in the state in which the conductive member 22 is in contact with an electrode current collector layer 140 and not in contact with an electrode layer 110, the conductive member 22 can be considered to be electrically connected to the electrode layer 110. Similarly, in the state in which the conductive member 32 is in contact with a counter-electrode current collector layer 150 and not in contact with a counter-electrode layer 120, the conductive member 32 can be considered to be electrically connected to the counter-electrode layer 120. As mentioned above, the conductive members 22 and 32 need not be physically in contact with an electrode layer 110 and a counter-electrode layer 120, respectively.

[Method of Manufacturing Battery]

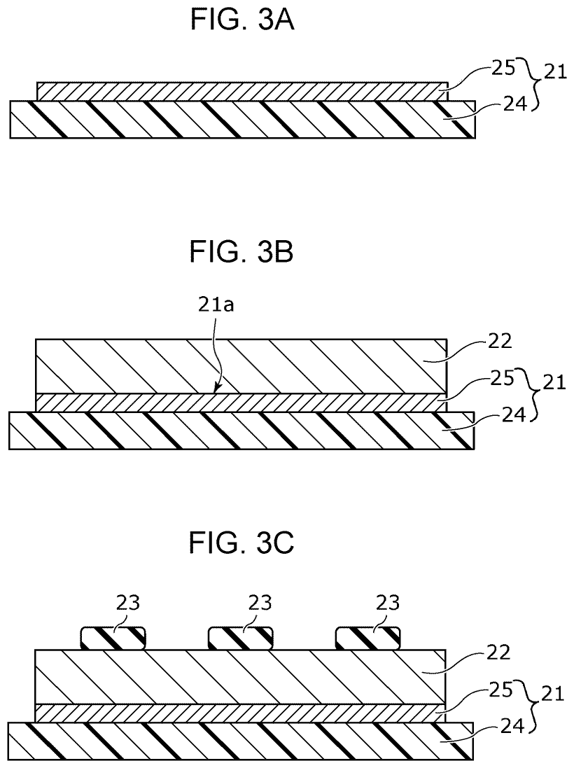

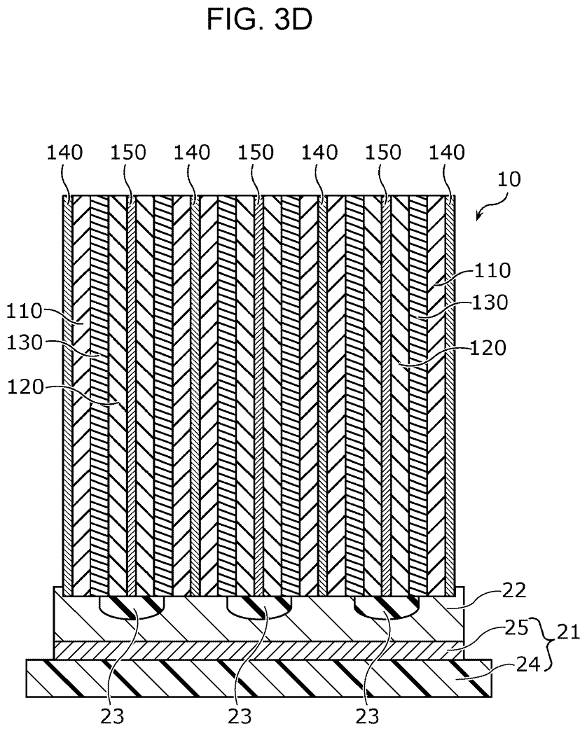

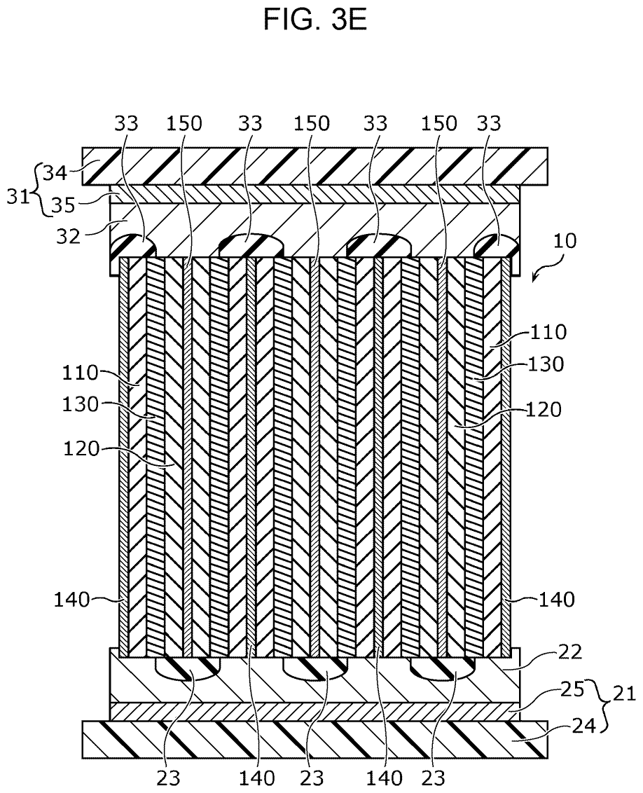

Next, a method of manufacturing the battery 1 according to the present embodiment will be described with reference to FIGS. 3A to 3E. FIGS. 3A to 3E are each a cross-sectional view for explaining a step of the method of manufacturing the battery 1 according to the present embodiment.

The method of manufacturing the battery 1 according to the present embodiment includes, for example, steps of forming the electrode connection member 20 and the counter-electrode connection member 30, a step of preparing the power-generation element 10, and a step of connecting the electrode connection member 20 and the counter-electrode connection member 30 to the power-generation element 10.

### <Step of Forming Connection Members>

First, a step of forming the electrode connection member 20 will be described with reference to FIGS. 3A to 3C.

As illustrated in FIG. 3A, a metal layer 25 is formed on a main surface of a resin film 24 to form a base material 21. The method of forming the metal layer 25 may be selected as appropriate and is not particularly limited. Examples of methods that can be used include a method of bonding a metal foil, vacuum vapor deposition, sputtering, and plating.

Next, as illustrated in FIG. 3B, a conductive member 22 is placed on the surface 21a of the base material 21. For example, the conductive member 22 is placed by at least one of application or printing. Specifically, a paint in the form of paste or ink containing the constituent substances of the conductive member 22 is applied so as to be in contact with the main surface of the metal layer 25 and dried to place the conductive member 22. Application methods that can be used include, for example, screen printing, dispensing, and mask printing but are not limited to these methods.

Next, as illustrated in FIG. 3C, insulating members 23 are placed on the surface of the conductive member 22 opposite to the base material 21 at specified positions. The placement of the insulating members 23 is performed by, for example, printing. Specifically, a paint in a paste form containing the constituent material of the insulating members 23 is applied to the main surface of the conductive member 22 by printing to place the insulating members 23. Printing methods that can be used include screen printing, gravure printing, and gravure offset printing but are not limited to these methods.

The positions where the insulating members 23 are placed are determined depending on the positions of the counter-electrode layers 120 and the counter-electrode current collector layers 150 on the side surface 11 of the power-generation element 10. Specifically, the insulating members 23 are placed such that when the side surface 11 of the power-generation element 10 and the electrode connection member 20 are connected, the insulating members 23 cover the end surfaces of the counter-electrode layers 120 and the counter-electrode current collector layers 150 and do not cover at least part of the end surfaces of at least either the electrode layers 110 or the electrode current collector layers 140.

The step of forming the counter-electrode connection member 30 is the same as or similar to the step of forming the electrode connection member 20, and hence, description thereof is omitted. In the step of forming the counter-electrode connection member 30, the positions at which the insulating members 33 are placed differ from the positions where the insulating member 23 are placed.

Specifically, the positions where the insulating members 33 are placed are determined depending on the positions of the electrode layers 110 and the electrode current collector layers 140 on the side surface 12 of the power-generation element 10. Specifically, the insulating members 33 are placed such that when the side surface 12 of the power-generation element 10 and the counter-electrode connection member 30 are connected, the insulating members 33 cover the end surfaces of the electrode layers 110 and the electrode current collector layers 140 and do not cover at least part of the end surfaces of at least either the counter-electrode layers 120 or the counter-electrode current collector layers 150.

Note that although the conductive member 22 covers approximately the entire surface 21a in FIG. 3B, the present disclosure is not limited to this configuration. For example, the conductive member 22 may be provided only at the portions where the insulating members 23 are not placed. In other words, the conductive member 22 may be provided at the positions corresponding to the electrode layers 110 and the electrode current collector layers 140 on the side surface 11 of the power-generation element 10. In this case, the insulating members 23 are in contact with the surface 21a of the base material 21.

### <Step of Preparing Power-Generation Element>

Next, a step of preparing power-generation element 10 will be described.

First, for example, a paint in a paste form in which the constituent material of the electrode layer 110 is kneaded together with a solvent is applied to a main surface of an electrode current collector layer 140 and dried to form an electrode layer 110. To increase the density of the electrode layer 110, the electrode layer 110 applied to the electrode current collector layer 140 may be pressed after the drying process.

Next, for example, a paint in a paste form in which the constituent material of the counter-electrode layer 120 is kneaded together with a solvent is applied to a main surface of a counter-electrode current collector layer 150 and dried to form a counter-electrode layer 120. To increase the density of the counter-electrode layer 120, the counter-electrode layer 120 applied to the counter-electrode current collector layer 150 may be pressed after the drying process. Note that either one of the electrode layer 110 and the counter-electrode layer 120 may be formed first, or both may be formed in parallel.

Next, for example, a paint in a paste form in which the constituent material of the solid electrolyte layer 130 is kneaded together with a solvent is applied to a main surface of the electrode layer 110 and/or the counter-electrode layer 120 and dried to form a solid electrolyte layer 130 or part of it. Alternatively, a paint in a paste form may be applied to a releasable film and dried to form a solid electrolyte layer 130.

Next, for example, the electrode current collector layer 140, the electrode layer 110, the solid electrolyte layer 130, the counter-electrode layer 120, and the counter-electrode current collector layer 150 are laminated in this order and pressed and bonded to form a battery cell 100. Examples of pressing methods that can be used include flat plate press, roll press, and isostatic press. From the viewpoint of improving the adhesiveness and density of each layer, heating may be performed while pressing. The heating temperature may be set within a range in which the material of each layer is not chemically changed by heat and is, for example, higher than or equal to 60° C. and lower than or equal to 200° C.

Note that counter-electrode layers 120 may be formed on both of the main surfaces of the counter-electrode current collector layer 150. In this case, an electrode current collector layer 140, an electrode layer 110, a solid electrolyte layer 130, a counter-electrode current collector layer 150 having counter-electrode layers 120 on both sides, a solid electrolyte layer 130, an electrode layer 110, and an electrode current collector layer 140 may be pressed and bonded in this order to form two battery cells 100 with a counter-electrode current collector layer 150 in between.

After a plurality of battery cells 100 are formed, the formed plurality of battery cells 100 are laminated to form a power-generation element 10. Specifically, a plurality of battery cells 100 are laminated such that the laminating order of an electrode layer 110, a solid electrolyte layer 130, and a counter-electrode layer 120 is alternately reversed for each battery cell 100. For example, a plurality of battery cells 100 may be integrated with an adhesive when being laminated. For example, all of the constituents mentioned above may be laminated, and pressed and bonded to integrate a plurality of battery cells 100.

In the present embodiment, a power-generation element 10 having a laminated plurality of battery cells 100 is cut in a direction intersecting the main surface 15 or 16 to form a side surface including a cut surface. Specifically, the power-generation element 10 is cut in a direction orthogonal to the main surface 15 or 16. More specifically, all of the battery cells 100, all of the electrode current collector layers 140, and all of the counter-electrode current collector layers 150 included in the power-generation element 10 are cut all together. For example, the power-generation element 10 is cut in parallel at two places, so that the parallel and flat side surfaces 11 and 12 can be formed. Not only the side surfaces 11 and 12 but also the side surfaces 13 and 14 may be formed by cutting all together.

Methods of cutting all together that can be used include, for example, shearing with a cutting tool, cutting with an end mill, grinding, laser cutting, and jet cutting but are not limited to these methods. From the viewpoint of improving the productivity and effective volume, the cutting method in the cutting step may be performed by a shearing process by cutting with a cutting tool. In the shearing process, the temperature of the power-generation element 10 is unlikely to increase during cutting, and the battery cell 100 is unlikely to deteriorate during cutting. From the viewpoint of improving the flatness of the side surfaces 11 and 12, the shearing process may be cutting with a ultrasonic cutter in which high frequency vibration is transmitted to the cutting edge.

Note that the side surfaces 11 and 12 need not be cut surfaces. For example, the side surfaces 11 and 12 of a power-generation element 10 may be formed by positioning and laminating a plurality of battery cells 100 having the same size. The same applies to the side surfaces 13 and 14.

### <Step of Connecting>

Next, a step of connecting the electrode connection member 20 and the counter-electrode connection member 30 to the power-generation element 10 will be described with reference to FIGS. 3D and 3E.

As illustrated in FIG. 3D, an electrode connection member 20 is connected to the side surface 11 of a prepared power-generation element 10. Specifically, the side surface 11 of the power-generation element 10 is positioned and placed on the electrode connection member 20 such that each insulating member 23 covers the end surfaces of the corresponding counter-electrode layers 120 and counter-electrode current collector layer 150. Then, the conductive member 22 on the base material 21 is joined to the electrode layers 110, on the side surface 11 of the power-generation element 10, so that the conductive member 22 is electrically connected to the plurality of electrode layers 110.

In this process, the conductive member 22 are connected when the conductive member 22 has some fluidity and is not solidified. With this process, the insulating members 23 are embedded into the conductive member 22, which enables connection to the flat side surface 11. In addition, this improves the adhesiveness between the conductive member 22 and the electrode layers 110 and electrode current collector layers 140, enabling reduction in the resistance of the connection.

For example, in the step of connecting the side surface 11 of the power-generation element 10 to the electrode connection member 20, these may be pressed. The method of pressing is not particularly limited and may be any method that enables the conductive member 22 to be in contact with the electrode layers 110 so as to electrically connect the electrode layers 110. In addition, to achieve more reliable electrical connection, the electrode connection member 20 may be heated in the connection step. The heating temperature may be set within a range in which the conductive member 22 and/or the insulating members 23 can be bonded to the side surface 11 of the power-generation element 10, and each material will not be chemically changed by heat. For example, the heating temperature is higher than or equal to 60° C. and lower than or equal to 200° C.

Next, as illustrated in FIG. 3E, a counter-electrode connection member 30 is connected to the side surface 12 of the power-generation element 10. The concrete connection method is the same as the connection method of the electrode connection member 20.

Note that either one of the electrode connection member 20 and the counter-electrode connection member 30 may be connected first, or both may be connected simultaneously.

Through the steps described above, a battery 1 as illustrated in FIG. 1 is manufactured.

Since the battery 1 according to the present embodiment enables the electrode connection member and the counter-electrode connection member to be in contact with and electrically connected to the side surfaces 11 and 12 of the power-generation element 10 to extend the electrodes and the counter electrodes, it is possible to increase the capacity density of the battery 1. In the method of manufacturing the battery 1 according to the present embodiment, the electrode connection member 20 and the counter-electrode connection member 30 can be formed separately from the step of preparing the power-generation element 10, which simplifies the manufacturing steps of the battery 1. In addition, since the conductive member and the insulating members are formed on the base material, and then these are joined to a side surface of the power-generation element 10, it is possible to manufacture the battery 1 with a high capacity density easily and precisely.

Use of the resin films 24 and 34 increases the robustness of the battery 1. This configuration also prevents the metal layer 25 or 35 from coming into contact with an outside object and causing the occurrence of a short circuit. Thus, it is possible to provide the battery 1 with high reliability. In addition, the shape of the metal layer 25 or 35 can be modified on the resin films 24 and 34, which increases the degree of freedom in wiring while maintaining the robustness of the battery 1.

### Embodiment 2

Next, the configuration of a battery according to Embodiment 2 will be described. In Embodiment 2, the configurations of the electrode connection member and the counter-electrode connection member differ from those in Embodiment 1. The following description focuses on the differences from Embodiment 1, and description of common points is omitted or simplified.

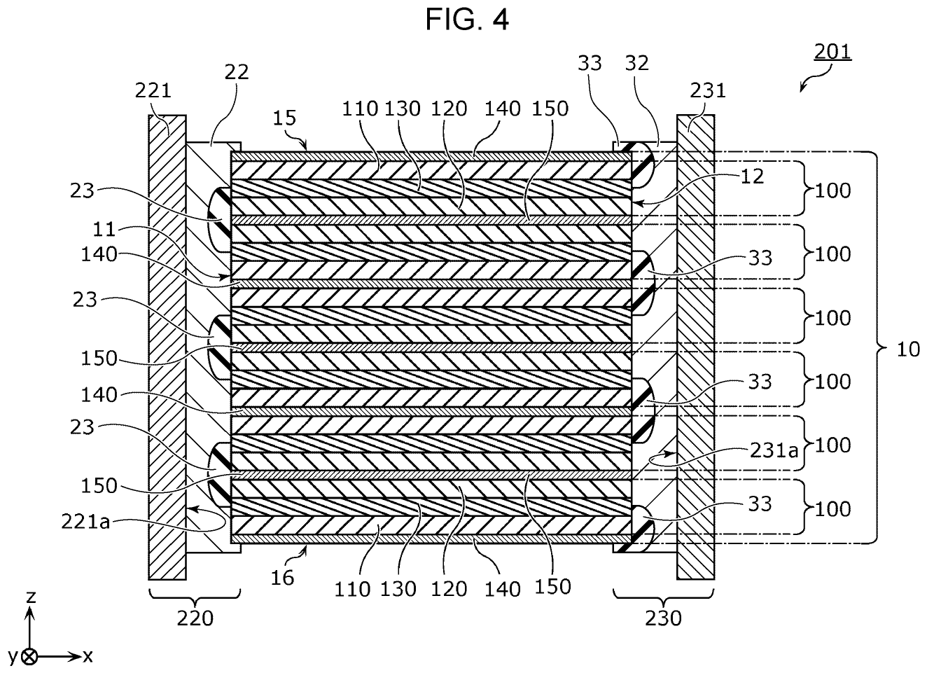

FIG. 4 is a cross-sectional view of a battery 201 according to the present embodiment.

As illustrated in FIG. 4, the battery 201 according to the present embodiment includes a power-generation element 10, an electrode connection member 220, and a counter-electrode connection member 230. The power-generation element 10 is the same as that in Embodiment 1.

### [Electrode Connection Member and Counter-Electrode Connection Member]

The electrode connection member 220 is an example of a first connection member. The electrode connection member 220 differs from the electrode connection member 20 according to Embodiment 1 in that the electrode connection member 220 includes a base material 221 instead of the base material 21.

The base material 221 is an example of a first base material and is a metal foil. A conductive member 22 is provided on a surface 221a of the metal-foil base material 221. With this configuration, the base material 221 is electrically connected to the electrode layers 110 of the plurality of battery cells 100 and the plurality of electrode current collector layers 140. Since the base material 221 has electrical conductivity, the base material 221 itself can be used for electrical connection between the battery 201 and another device.

For the constituent material of the metal-foil base material 221, a material having a high electrical conductivity can be used. Examples of materials that can be used for the base material 221 include copper, silver, palladium, nickel, aluminum, iron, stainless steel (SUS), titanium, zinc, and an alloy of some of these. Note that the metal foil denotes a metal member having a substantially uniform thickness, which may also be referred to as a metal plate.

The thickness of the base material 221 is, for example, greater than or equal to 5 μm and less than or equal to 100 μm but is not limited to this range. A thicker base material 221 reduces the electrical resistance of the base material 221. In addition, it is possible to keep the strength of the base material 221 larger than or equal to a certain degree, which increases the robustness of the battery 201. In contrast, a thinner base material 221 mitigates a decrease in the capacity density of the battery 201. Note that the thickness of the base material 221 need not be uniform, and the base material 221 may be a metal member having portions with different thicknesses.

The counter-electrode connection member 230 is an example of a second connection member. The counter-electrode connection member 230 differs from the counter-electrode connection member 30 according to Embodiment 1 in that the counter-electrode connection member 230 includes a base material 231 instead of the base material 31.

The base material 231 is an example of a second base material and is a metal foil. A conductive member 32 is provided on a surface 231a of the metal-foil base material 231. With this configuration, the base material 231 is electrically connected to the counter-electrode layers 120 of the plurality of battery cells 100 and the plurality of counter-electrode current collector layers 150. Since the base material 231 has electrical conductivity, the base material 231 itself can be used for electrical connection between the battery 201 and another device.

For the constituent material of the base material 231, the same material that can be used for the base material 221 can be used. The thickness of the base material 231 is, for example, greater than or equal to 5 μm and less than or equal to 100 μm but is not limited to this range. The base material 231 with this configuration provides the effects the same as or similar to those of the base material 221.

### [Method of Manufacturing Battery]

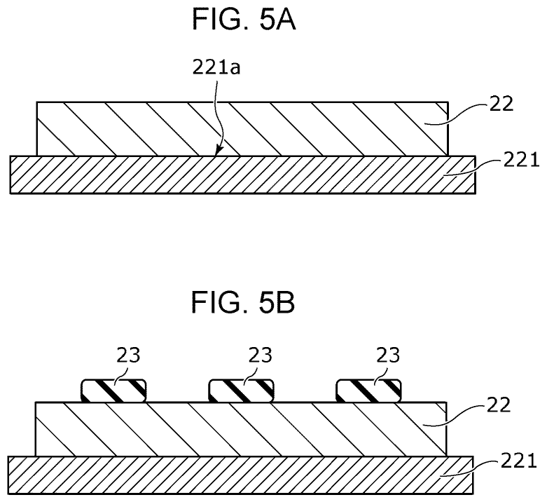

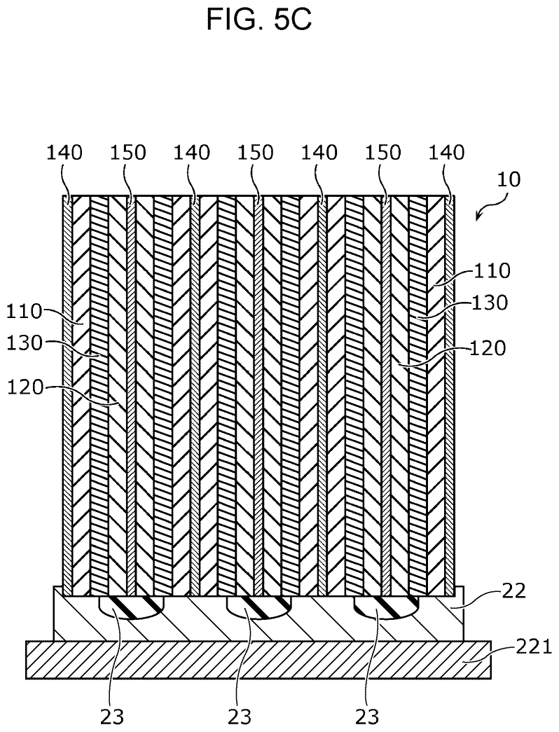

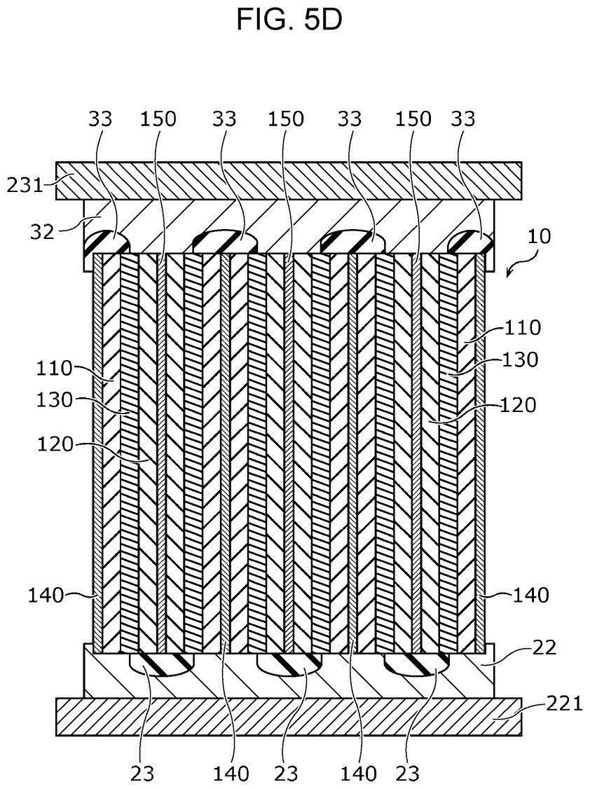

Next, a method of manufacturing the battery 201 according to the present embodiment will be described with reference to FIGS. 5A to 5D. FIGS. 5A to 5D are each a cross-sectional view for explaining a step of the method of manufacturing the battery 201 according to the present embodiment.

The method of manufacturing the battery 201 according to the present embodiment includes, for example, steps of forming the electrode connection member 220 and the counter-electrode connection member 230, a step of preparing the power-generation element 10, and a step of connecting the electrode connection member 220 and the counter-electrode connection member 230 to the power-generation element 10. The step of preparing the power-generation element 10 is the same as that in Embodiment 1.

### <Step of Forming Connection Members>

First, a step of forming the electrode connection member 220 will be described with reference to FIGS. 5A and 5B.

As illustrated in FIG. 5A, a conductive member 22 is placed on the surface 221a, which is a main surface, of a metal-foil base material 221. The placement of the conductive member 22 is performed by at least one of application or printing as in Embodiment 1.

Next, as illustrated in FIG. 5B, insulating members 23 are placed on the surface of the conductive member 22 opposite to the base material 221 at specified positions. The placement of the insulating members 23 is performed by, for example, printing.

The step of forming the counter-electrode connection member 230 is the same as or similar to the step of forming the electrode connection member 220, and hence, description thereof is omitted. In the step of forming the counter-electrode connection member 230, the positions at which the insulating members 33 are placed differ from the positions where the insulating members 23 are placed.

### <Step of Connecting>

Next, a step of connecting the electrode connection member 220 and the counter-electrode connection member 230 to the power-generation element 10 will be described with reference to FIGS. 5C and 5D.

As illustrated in FIG. 5C, an electrode connection member 220 is connected to the side surface 11 of a prepared power-generation element 10. Specifically, the side surface 11 of the power-generation element 10 is positioned and placed on the electrode connection member 220 such that each insulating member 23 covers the end surfaces of the corresponding counter-electrode layers 120 and counter-electrode current collector layer 150. Then, the conductive member 22 on the base material 221 is joined to the electrode layers 110, on the side surface 11 of the power-generation element 10, so that the conductive member 22 is electrically connected to the plurality of electrode layers 110.

Next, as illustrated in FIG. 5D, a counter-electrode connection member 230 is connected to the side surface 12 of the power-generation element 10. The concrete connection method is the same as the connection method of the electrode connection member 220. During the steps of connecting the electrode connection member 220 and the counter-electrode connection member 230, pressing and/or heating may be performed as in Embodiment 1.

Through the steps described above, a battery 201 as illustrated in FIG. 4 is manufactured.

Since the battery 201 according to the present embodiment includes the base material 221 which is a relatively thick metal foil, it enables low-resistance electrical connection. This makes it possible to manufacture the battery 201 with a high capacity density easily and precisely.

### Embodiment 3

Next, the configuration of a battery according to Embodiment 3 will be described. In Embodiment 3, the configurations of the electrode connection member and the counter-electrode connection member differ from those in Embodiment 1. The following description focuses on the differences from Embodiment 1, and description of common points is omitted or simplified.

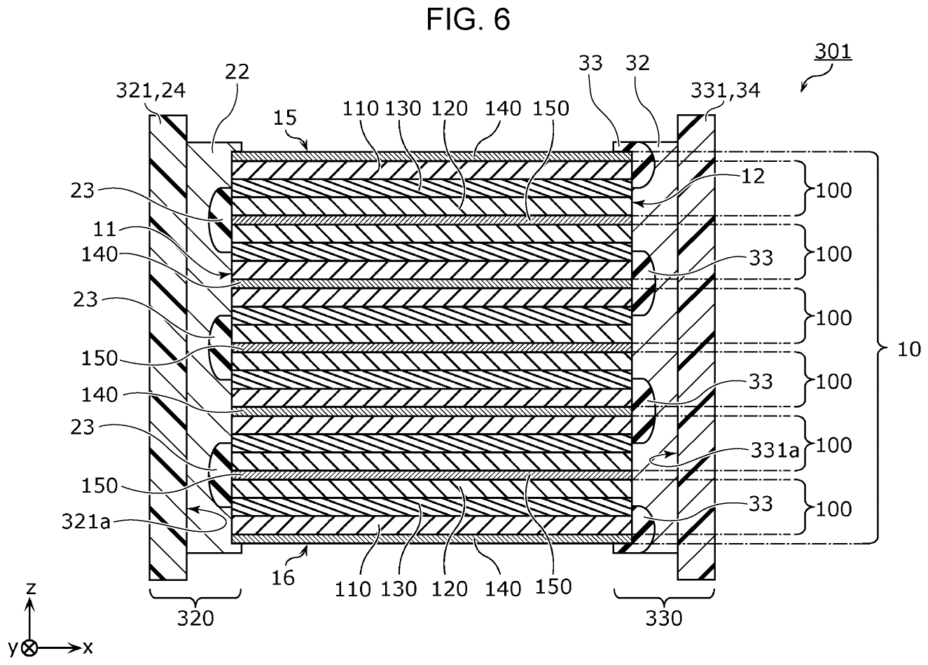

FIG. 6 is a cross-sectional view of a battery 301 according to the present embodiment.

As illustrated in FIG. 6, the battery 301 according to the present embodiment includes a power-generation element 10, an electrode connection member 320, and a counter-electrode connection member 330. The power-generation element 10 is the same as that in Embodiment 1.

### [Electrode Connection Member and Counter-Electrode Connection Member]

The electrode connection member 320 is an example of a first connection member. The electrode connection member 320 differs from the electrode connection member 20 according to Embodiment 1 in that the electrode connection member 320 includes a base material 321 instead of the base material 21.

The base material 321 is an example of a first base material and is a resin film 24. Specifically, the base material 321 has a configuration of the base material 21 according to Embodiment 1 from which the metal layer 25 is removed. The conductive member 22 is provided on a surface 321a of the base material 321. The plurality of electrode layers 110 are electrically connected only by the conductive member 22 in the present embodiment, and hence, the conductive member 22 is not divided by the insulating members 23.

The counter-electrode connection member 330 is an example of a second connection member. The counter-electrode connection member 330 differs from the counter-electrode connection member 30 according to Embodiment 1 in that the counter-electrode connection member 330 includes a base material 331 instead of the base material 31.

The base material 331 is an example of a second base material and is a resin film 34. Specifically, the base material 331 has a configuration of the base material 31 according to Embodiment 1 from which the metal layer 35 is removed. The conductive member 32 is provided on a surface 331a of the base material 331. The plurality of counter-electrode layers 120 are electrically connected only by the conductive member 32 in the present embodiment, and hence, the conductive member 32 is not divided by the insulating members 33.

### [Method of Manufacturing]

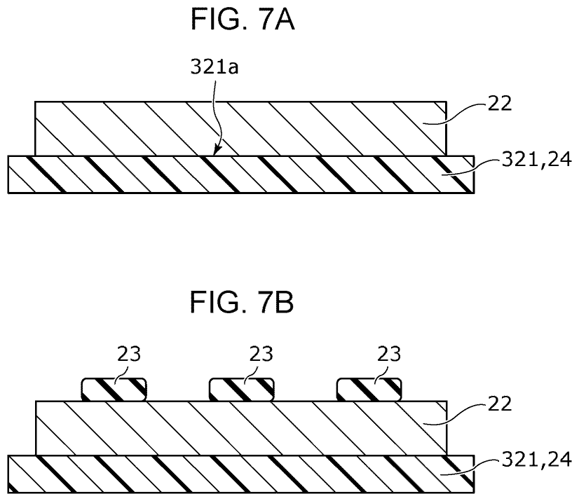

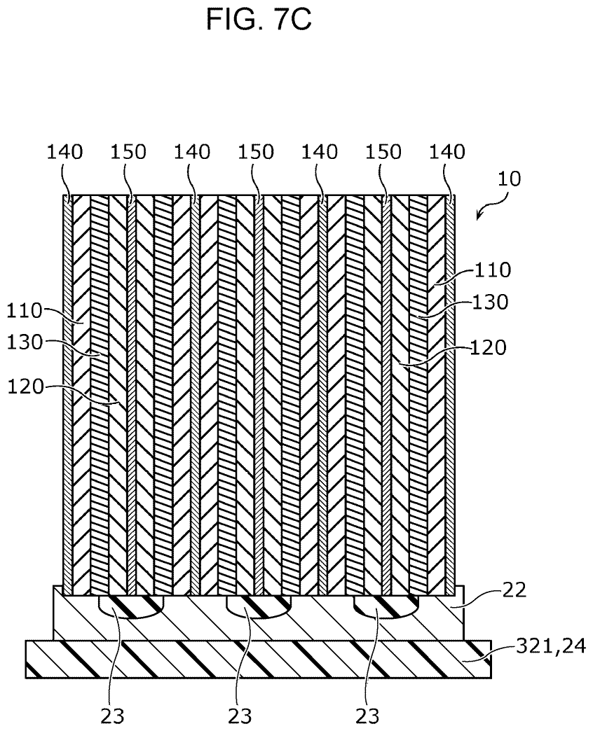

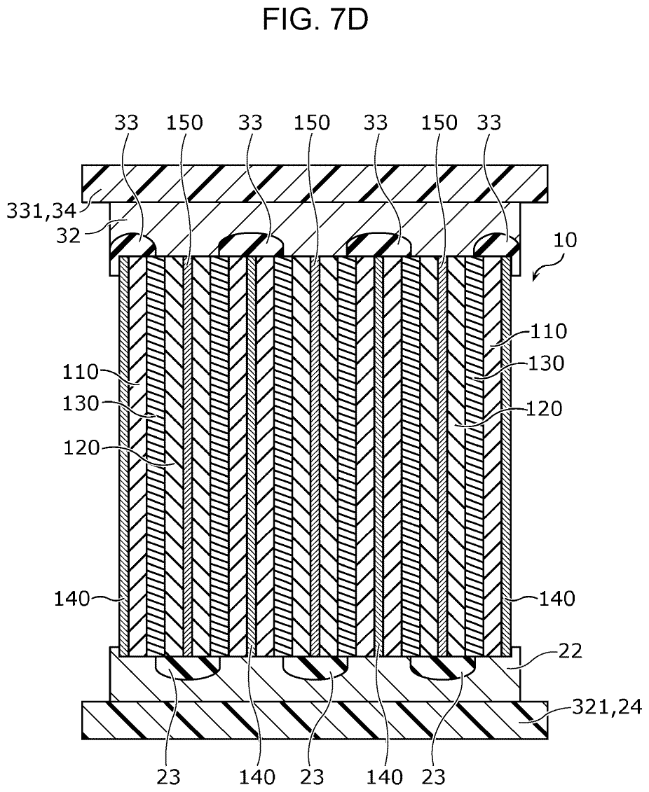

Next, a method of manufacturing the battery 301 according to the present embodiment will be described with reference to FIGS. 7A to 7D. FIGS. 7A to 7D are each a cross-sectional view for explaining a step of the method of manufacturing the battery 301 according to the present embodiment.

The method of manufacturing the battery 301 according to the present embodiment includes, for example, steps of forming the electrode connection member 320 and the counter-electrode connection member 330, a step of preparing the power-generation element 10, and a step of connecting the electrode connection member 320 and the counter-electrode connection member 330 to the power-generation element 10. The step of preparing the power-generation element 10 is the same as that in Embodiment 1.

### <Step of Forming Connection Members>

First, a step of forming the electrode connection member 320 will be described with reference to FIGS. 7A and 7B.

As illustrated in FIG. 7A, a conductive member 22 is placed on a surface 321a, which is a main surface, of a base material 321 which is a resin film 24. The placement of the conductive member 22 is performed by at least one of application or printing as in Embodiment 1.

Next, as illustrated in FIG. 7B, insulating members 23 are placed on the surface of the conductive member 22 opposite to the base material 321 at specified positions. The placement of the insulating members 23 is performed by, for example, printing.

The step of forming the counter-electrode connection member 330 is the same as or similar to the step of forming the electrode connection member 320, and hence, description thereof is omitted. In the step of forming the counter-electrode connection member 330, the positions at which the insulating members 33 are placed differ from the positions where the insulating members 23 are placed.

### <Step of Connecting>

Next, a step of connecting the electrode connection member 320 and the counter-electrode connection member 330 to the power-generation element 10 will be described with reference to FIGS. 7C and 7D.

As illustrated in FIG. 7C, an electrode connection member 320 is connected to the side surface 11 of a prepared power-generation element 10. Specifically, the side surface 11 of the power-generation element 10 is positioned and placed on the electrode connection member 320 such that each insulating member 23 covers the end surfaces of the corresponding counter-electrode layers 120 and counter-electrode current collector layer 150. The conductive member 22 on the base material 321 is joined to the electrode layers 110, on the side surface 11 of the power-generation element 10, so that the conductive member 22 is electrically connected to the plurality of electrode layers 110.

Next, as illustrated in FIG. 7D, a counter-electrode connection member 330 is connected to the side surface 12 of the power-generation element 10. The concrete connection method is the same as the connection method of the electrode connection member 320. During the steps of connecting the electrode connection member 320 and the counter-electrode connection member 330, pressing and/or heating may be performed as in Embodiment 1.

In the battery 301 according to the present embodiment, the side surfaces 11 and 12 of the power-generation element 10 are protected by the resin films 24 and 34. This makes it possible to provide a robust battery 301 with high reliability. Since the metal layers 25 and 35 are not present, the volumes of the electrode connection member 320 and the counter-electrode connection member 330 can be small. This makes it possible to achieve a battery 301 with a high capacity density.

### Embodiment 4

Next, a method of manufacturing a battery according to Embodiment 4 will be described. Embodiment 4 differs from Embodiments 1 to 3 in that insulating members are formed on the side surfaces of the power-generation element. The following description focuses on the differences from Embodiments 1 to 3, and description of common points is omitted or simplified.

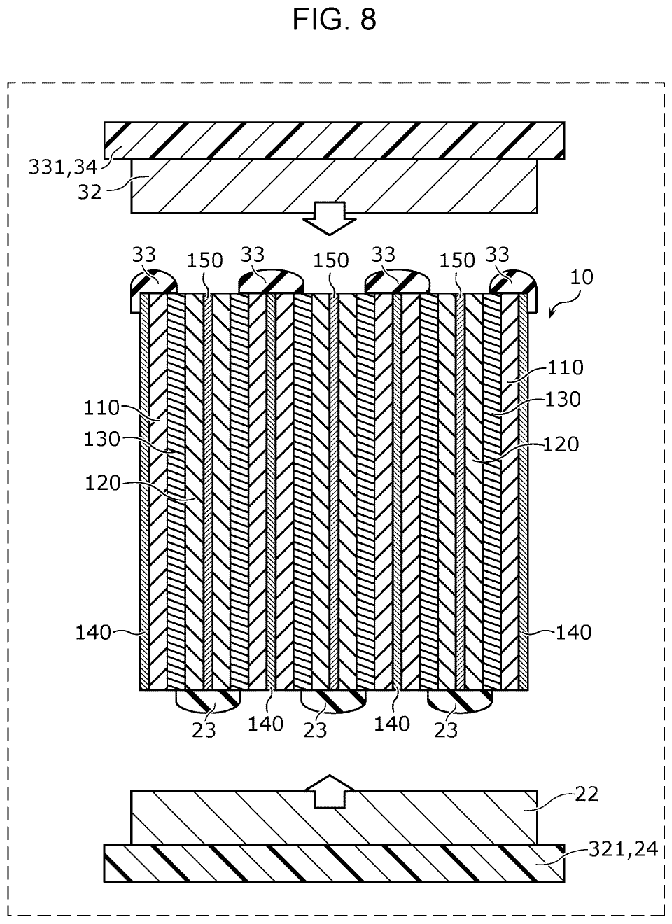

FIG. 8 is a cross-sectional view for explaining a step of a method of manufacturing a battery according to the present embodiment. Note that FIG. 8 illustrates a step of a method of manufacturing the battery 301, described in Embodiment 3, including the electrode connection member 320 and the counter-electrode connection member 330.

The method of manufacturing the battery 301 according to the present embodiment, as in Embodiment 3, includes, for example, steps of forming the electrode connection member 320 and the counter-electrode connection member 330, a step of preparing the power-generation element 10, and a step of connecting the electrode connection member 320 and the counter-electrode connection member 330 to the power-generation element 10.

In the steps of forming the electrode connection member 320 and the counter-electrode connection member 330, as illustrated in FIG. 8, the insulating members 23 and 33 are not formed. Specifically, as illustrated in FIG. 7A, the base material 321 with the conductive member 22 placed on the surface 321a is used as the electrode connection member 320. The same applies to the counter-electrode connection member 330.

In the step of preparing the power-generation element 10, a plurality of battery cells 100 are laminated, the laminated battery cells 100 are cut all together as necessary to form flat side surfaces 11 and 12, and then, insulating members 23 and 33 are placed on the side surfaces 11 and 12. Specifically, on the side surface 11, the insulating members 23 are placed so as to cover the entire end surfaces of the counter-electrode layers 120 and the counter-electrode current collector layers 150. On the side surface 12, the insulating members 33 are placed so as to cover the entire end surfaces of the electrode layers 110 and the electrode current collector layers 140.

After that, the base material 321 on which the conductive member 22 is placed is connected to the side surface 11 of the power-generation element 10 on which the insulating members 23 are placed. The base material 331 on which the conductive member 32 is placed is connected to the side surface 12 of the power-generation element 10 on which the insulating members 33 are placed.

In the present embodiment, in the step of preparing the power-generation element 10, the counter-electrode layers 120 and the counter-electrode current collector layers 150 are not exposed on the side surface 11, and the electrode layers 110 and the electrode current collector layers 140 are not exposed on the side surface 12. Hence, even if the positioning of the electrode connection member 320 and the counter-electrode connection member 330 has some positional errors during connection, it is possible to prevent the occurrence of a short circuit. In other words, the accuracy required for the positioning need not be high, which makes it easy to manufacture the battery 301.

Although the description of the present embodiment is based on an example of manufacturing the battery 301 according to Embodiment 3, the present embodiment is applicable to the methods of manufacturing the battery 1 according to Embodiment 1 and the battery 201 according to Embodiment 2.

### Embodiment 5

Next, the configuration of a battery according to Embodiment 5 will be described. In Embodiment 5, the base materials of the electrode connection member and the counter-electrode connection member differ from those in Embodiment 1. The following description focuses on the differences from Embodiment 1, and description of common points is omitted or simplified.

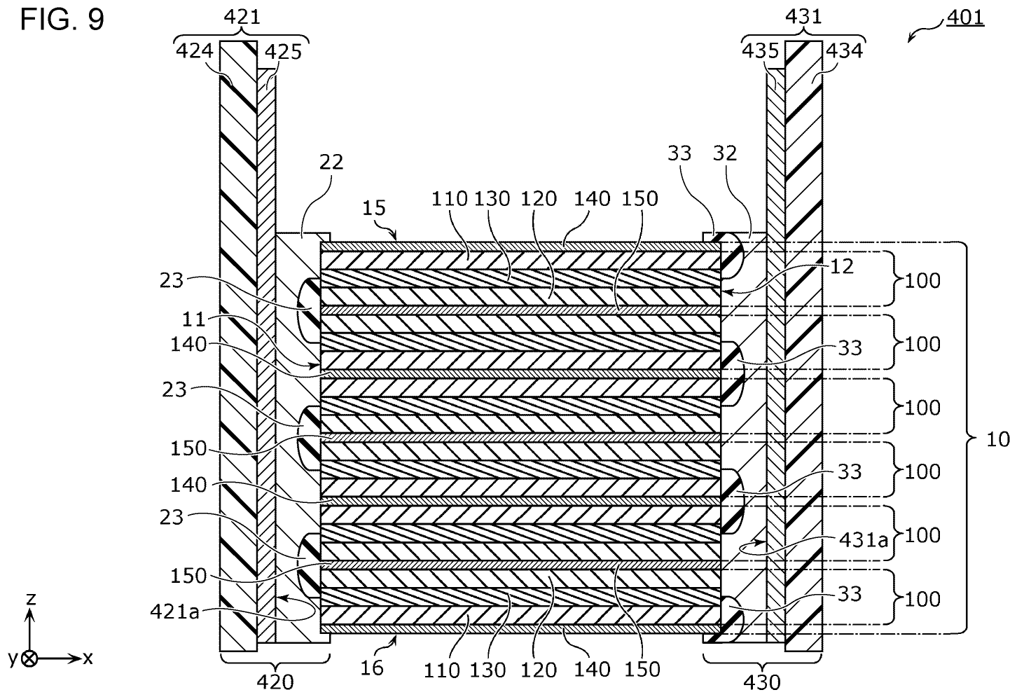

FIG. 9 is a cross-sectional view of a battery 401 according to the present embodiment.

As illustrated in FIG. 9, the battery 401 according to the present embodiment includes a power-generation element 10, an electrode connection member 420, and a counter-electrode connection member 430. The power-generation element 10 is the same as that in Embodiment 1.

### [Electrode Connection Member]

The electrode connection member 420 is an example of a first connection member. The electrode connection member 420 differs from the electrode connection member 20 according to Embodiment 1 in that the electrode connection member 420 includes a base material 421 instead of the base material 21.

The base material 421 is an example of a first base material and includes a resin film 424 and a metal layer 425. The resin film 424 and the metal layer 425 have configurations in which the resin film 24 and the metal layer 25 according to Embodiment 1 are extended in a direction away from the side surface 11 of the power-generation element 10. In other words, the base material 421 according to the present embodiment extends in a direction away from the side surface 11.

The phrase “a direction away from the side surface 11” mentioned here refers to a direction parallel to the side surface 11 (in the z-axis direction) but is not limited to this direction. For example, the base material 421 may be curved or bent and then extend in a direction orthogonal to the side surface 11 (for example, the negative direction of the x-axis). Alternatively, the base material 421 may be curved or bent and then extend in a direction obliquely intersecting the side surface 11.

The extended length of the base material 421 is not particularly limited and may be, for example, longer than or equal to the thickness of the power-generation element 10 (the length in the z-axis direction). Although the base material 421 extends mainly in the positive direction of the z-axis in FIG. 9, the base material 421 may extend also in the negative direction of the z-axis. The extension length of the base material 421 on the positive side of the z-axis may be equal to the extension length of the base material 421 on the negative side of the z-axis.

The conductive member 22 is provided on a surface 421a of the base material 421. Although in the present embodiment, the conductive member 22 is provided in the region of the surface 421a facing the side surface 11 of the power-generation element 10, and the conductive member 22 is not provided in the region of the surface 421a not facing the side surface 11, the present disclosure is not limited to this configuration. The conductive member 22 may extend in the manner the same as or similar to that of the base material 421. For example, the conductive member 22 may be provided so as to cover the entire surface 421a, in other words, may be provided also in the extension portion of the surface 421a. Note that the region facing the side surface 11 refers to the region overlapping the side surface 11 in plan view of the side surface 11.

### [Counter-Electrode Connection Member]

The counter-electrode connection member 430 is an example of a second connection member. The counter-electrode connection member 430 differs from the counter-electrode connection member 30 according to Embodiment 1 in that the counter-electrode connection member 430 includes a base material 431 instead of the base material 31.

The base material 431 is an example of a second base material and includes a resin film 434 and a metal layer 435. The resin film 434 and the metal layer 435 have configurations in which the resin film 34 and the metal layer 35 according to Embodiment 1 are extended in a direction away from the side surface 12 of the power-generation element 10. In other words, the base material 431 according to the present embodiment extends in a direction away from the side surface 12.

The extending direction and extended length of the base material 431 may be modified in the manner the same as or similar to that of the base material 421. Although the base material 431 in the example illustrated in FIG. 9 extends mainly in the positive direction of the z-axis in the same manner as the base material 421, the present disclosure is not limited to this configuration. The main extending direction of the base material 431 may differ from the extending direction of the base material 421. For example, in a configuration in which the main extending direction of the base material 431 is opposite to the extending direction of the base material 421, the metal layer 425 and the metal layer 435 can be away from each other, and this will prevent the occurrence of a short circuit. Note that the phrase “the main extending direction” refers to the direction in which the base material extends by the longest length.

The conductive member 32 is provided on a surface 431a of the base material 431. Although in the present embodiment, the conductive member 32 is provided in the region of the surface 431a facing the side surface 12 of the power-generation element 10, and the conductive member 32 is not provided in the region of the surface 431a not facing the side surface 12, the present disclosure is not limited to this configuration. The conductive member 32 may extend in the manner the same as or similar to that of the base material 431. For example, the conductive member 32 may be provided so as to cover the entire surface 431a, in other words, may be provided also in the extension portion of the surface 431a.

In the present embodiment, both the metal layers 425 and 435 extend. In other words, in plan view of the metal layer 425 (when viewed in the x-axis direction), the region of the main surface of the metal layer 425 that is not covered with the power-generation element 10 is large. The same is true of the metal layer 435. The extension portion of each of the metal layers 425 and 435 can be used for electrical connection to another device.

The method of manufacturing the battery 401 according to the present embodiment is the same as or similar to the method of manufacturing the battery 1 according to Embodiment 1. Instead of the resin films 24 and 34, resin films 424 and 434 longer than the thickness of the power-generation element 10 are prepared, and metal layers 425 and 435 are formed in ranges longer than the thickness of the power-generation element 10.

In the battery 401 according to the present embodiment, the extension portion of each of the base materials 421 and 431 can be used for electrical connection to another device.

### Embodiment 6

Next, the configuration of a battery according to Embodiment 6 will be described.

In Embodiment 6, the base materials of the electrode connection member and the counter-electrode connection member differ from those in Embodiment 2. The following description focuses on the differences from Embodiments 2 and 5, and description of common points is omitted or simplified.

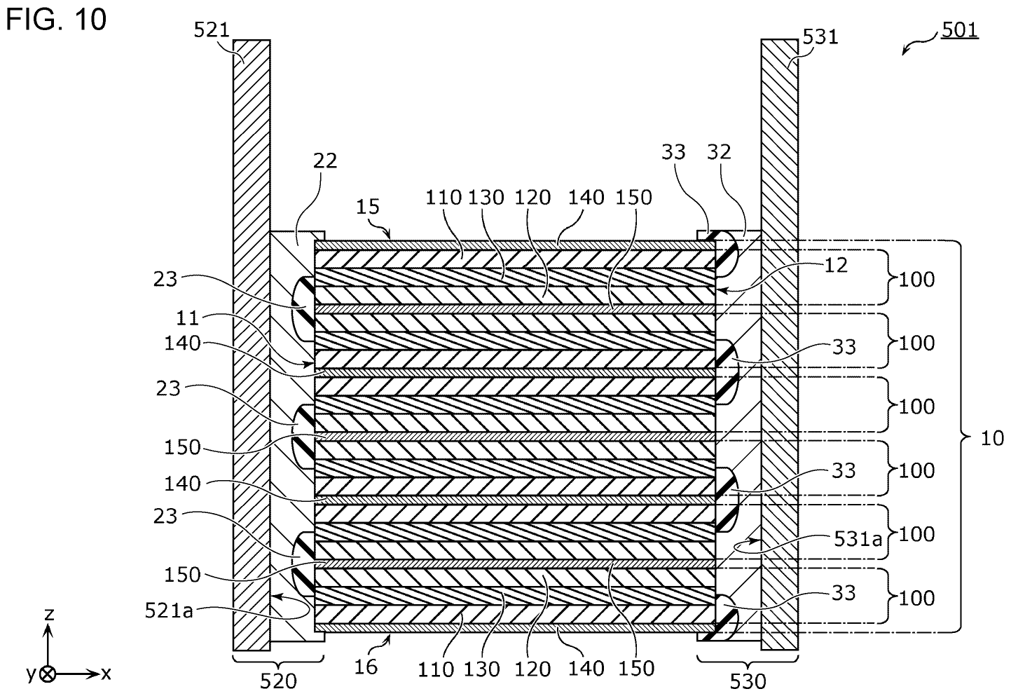

FIG. 10 is a cross-sectional view of a battery 501 according to the present embodiment.

As illustrated in FIG. 10, the battery 501 according to the present embodiment includes a power-generation element 10, an electrode connection member 520, and a counter-electrode connection member 530. The power-generation element 10 is the same as that in Embodiment 1.

### [Electrode Connection Member and Counter-Electrode Connection Member]

The electrode connection member 520 is an example of a first connection member. The electrode connection member 520 differs from the electrode connection member 220 according to Embodiment 2 in that the electrode connection member 520 includes a base material 521 instead of the base material 221.

The base material 521 is an example of a first base material and is a metal foil. The base material 521 has a configuration in which the base material 221 according to an embodiment is extended in a direction away from the side surface 11 of the power-generation element 10. In other words, the base material 521 according to the present embodiment extends in a direction away from the side surface 11. A conductive member 22 is provided in the region of a surface 521a of the base material 521 facing the side surface 11. The extending direction and the extended length of the base material 521 are the same as those of the base material 421 according to Embodiment 5, and hence, modifications applicable to the base material 421 are also applicable to the base material 521. The conductive member 22 may extend in the manner the same as or similar to that of the base material 521.

The counter-electrode connection member 530 is an example of a second connection member. The counter-electrode connection member 530 differs from the counter-electrode connection member 230 according to Embodiment 2 in that the counter-electrode connection member 530 includes a base material 531 instead of the base material 231.

The base material 531 is an example of a second base material and is a metal foil. The base material 531 has a configuration in which the base material 231 according to an embodiment is extended in a direction away from the side surface 12 of the power-generation element 10. In other words, the base material 531 according to the present embodiment extends in a direction away from the side surface 12. A conductive member 32 is provided in the region of a surface 531a of the base material 531 facing the side surface 12. The extending direction and the extended length of the base material 531 are the same as those of the base material 431 according to Embodiment 5, and hence, modifications applicable to the base material 431 are also applicable to the base material 531. The conductive member 32 may extend in the manner the same as or similar to that of the base material 531.

The method of manufacturing the battery 501 according to the present embodiment is the same as or similar to the method of manufacturing the battery 201 according to Embodiment 2. Instead of the base materials 221 and 231, metal foils longer than the thickness of the power-generation element 10 are prepared for the base materials 521 and 531.

In the battery 501 according to the present embodiment, the extension portion of each of the base materials 521 and 531 can be used for electrical connection to another device.

### Embodiment 7

Next, the configuration of a battery according to Embodiment 7 will be described. In Embodiment 7, the base materials of the electrode connection member and the counter-electrode connection member differ from those in Embodiment 3. The following description focuses on the differences from Embodiments 3 and 5, and description of common points is omitted or simplified.

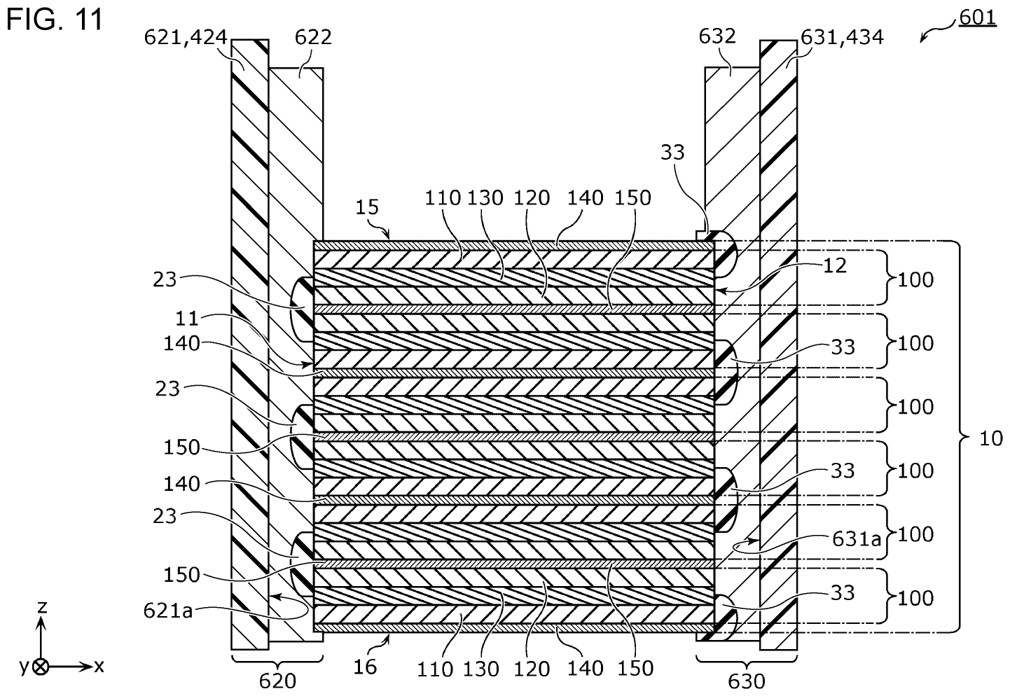

FIG. 11 is a cross-sectional view of a battery 601 according to the present embodiment.

As illustrated in FIG. 11, the battery 601 according to the present embodiment includes a power-generation element 10, an electrode connection member 620, and a counter-electrode connection member 630. The power-generation element 10 is the same as that in Embodiment 1.

### [Electrode Connection Member and Counter-Electrode Connection Member]

The electrode connection member 620 is an example of a first connection member. The electrode connection member 620 differs from the electrode connection member 420 according to Embodiment 5 in that the electrode connection member 620 includes a base material 621 and a conductive member 622 instead of the base material 421 and the conductive member 22.

The base material 621 is an example of a first base material and is a resin film 424. Specifically, the base material 621 has a configuration of the base material 421 according to Embodiment 5 from which the metal layer 425 is removed. The conductive member 622 is provided on a surface 621a of the base material 621. The plurality of electrode layers 110 are electrically connected only by the conductive member 622 in the present embodiment, and hence, the conductive member 622 is not divided by the insulating members 23. In the present embodiment, not only the base material 621 but also the conductive member 622 extends in a direction away from the side surface 11.

The counter-electrode connection member 630 is an example of a second connection member. The counter-electrode connection member 630 differs from the counter-electrode connection member 430 according to Embodiment 5 in that the counter-electrode connection member 630 includes a base material 631 and a conductive member 632 instead of the base material 431 and the conductive member 32.

The base material 631 is an example of a second base material and is a resin film 434. Specifically, the base material 631 has a configuration of the base material 431 according to Embodiment 5 from which the metal layer 435 is removed. The conductive member 632 is provided on a surface 631a of the base material 631. The plurality of counter-electrode layers 120 are electrically connected only by the conductive member 632 in the present embodiment, and hence, the conductive member 632 is not divided by the insulating members 33. In the present embodiment, not only the base material 631 but also the conductive member 632 extends in a direction away from the side surface 12.

The method of manufacturing the battery 601 according to the present embodiment is the same as or similar to the method of manufacturing the battery 401 according to Embodiment 5. A conductive member 622 is placed on the surface 621a of a base material 621 in a range longer than the thickness of the power-generation element 10, and a conductive member 632 is placed on the surface 631a of a base material 631 in a range longer than the thickness of the power-generation element 10. For example, the conductive members 622 and 632 may be placed on the entire surfaces of the surfaces 621a and 631a, respectively.

In the battery 601 according to the present embodiment, the extension portion of each of the conductive members 622 and 632 can be used for electrical connection to another device.

### Embodiment 8

Next, the configuration of a battery according to Embodiment 8 will be described. Embodiment 8 differs from Embodiment 1 in that a base material is in contact with the main surfaces of the power-generation element. The following description focuses on the differences from Embodiments 2 and 6, and description of common points is omitted or simplified.

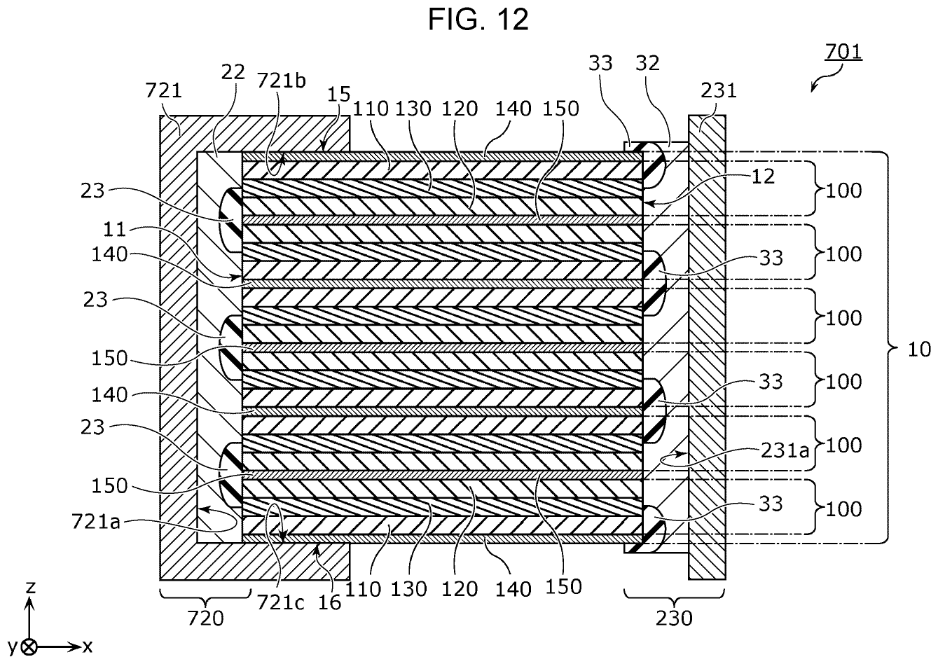

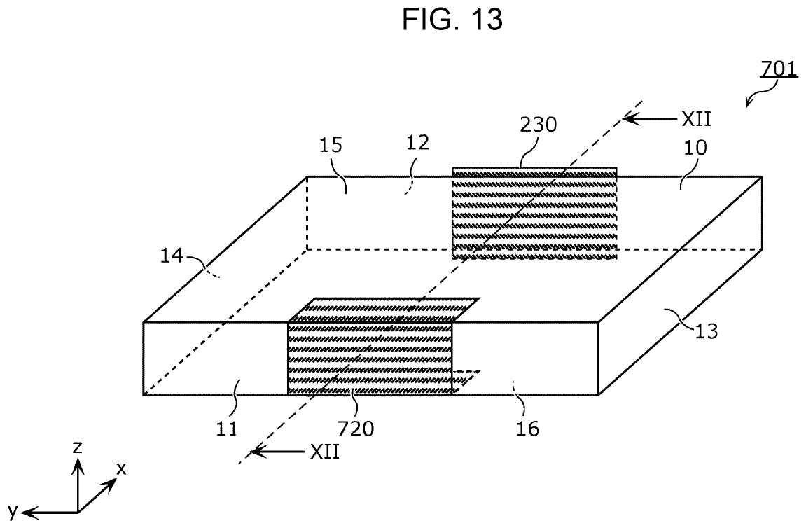

FIG. 12 is a cross-sectional view of a battery 701 according to the present embodiment. FIG. 12 is a cross-sectional view taken along line XII-XII in FIG. 13. FIG. 13 is a perspective view of the battery 701 according to the present embodiment.

As illustrated in FIGS. 12 and 13, the battery 701 according to the present embodiment includes a power-generation element 10, an electrode connection member 720, and a counter-electrode connection member 230. The power-generation element 10 and the counter-electrode connection member 230 are the same as those in Embodiment 2.

The electrode connection member 720 differs from the electrode connection member 520 according to Embodiment 6 in that the electrode connection member 720 includes a base material 721 instead of the base material 521. The base material 721 is a metal foil.

The metal-foil base material 721 has a configuration in which the portions of the base material 521 according to Embodiment 6 extending in direction away from the side surface 11 are folded. Specifically, the base material 721 has not only a surface 721a facing the side surface 11 of the power-generation element 10 but also surfaces 721b and 721c facing the main surfaces 15 and 16, respectively, of the power-generation element 10.

As illustrated in FIG. 12, the base material 721 is connected to both the main surfaces 15 and 16 of the power-generation element 10. Specifically, the base material 721 is connected to the main surface 15 which is the upper surface of the electrode current collector layer 140 located in the uppermost layer of the power-generation element 10, and is also connected to the main surface 16 which is the lower surface of the electrode current collector layer 140 located in the lowermost layer of the power-generation element 10.

The method of manufacturing the battery 701 according to the present embodiment is the same as or similar to the method of manufacturing the battery 501 according to Embodiment 6. For example, a base material 721 longer than the thickness of the power-generation element 10 is connected to the side surface 11 of a power-generation element 10, and then, the extension portions of the base material 721 are bent so as to make contact with the main surfaces 15 and 16 by pressing or the like. With this process, the surface 721b of the base material 721 makes contact with the main surface 15, and the surface 721c of the base material 721 makes contact with the main surface 16.

In the battery 701 according to the present embodiment, the contact area between the metal-foil base material 721 and the electrode current collector layer 140 is larger, which decreases the resistance of the connection.

In the present embodiment, since both the main surfaces 15 and 16 of the power-generation element 10 are main surfaces of electrode current collector layers 140, the base material 721 of the electrode connection member 720 is brought into contact with both the main surfaces 15 and 16. In the case in which at least one of the main surface 15 or 16 of the power-generation element 10 is a main surface of a counter-electrode current collector layer 150, the base material 231 of the counter-electrode connection member 230 may be brought into contact with each of the main surfaces 15 and 16.

Although the battery 701 is an example including a metal-foil base material as with the battery 501 according to Embodiment 6, the present disclosure is not limited to this configuration. The battery 701 may include a base material including a resin film and a metal layer or a base material including only a resin film, as with the battery 401 according to Embodiment 5 or the battery 601 according to Embodiment 7. Note that in the case of a base material including only a resin film, a conductive member 22 or 32 located on the surface of the resin film is brought into contact with the main surface 15 or 16 of the power-generation element 10.

### Embodiment 9

Next, the configuration of a battery according to Embodiment 9 will be described. Embodiment 9 differs from Embodiment 5 in that Embodiment 9 includes an outer case enclosing the power-generation element. The following description focuses on the differences from Embodiment 5, and description of common points is omitted or simplified.

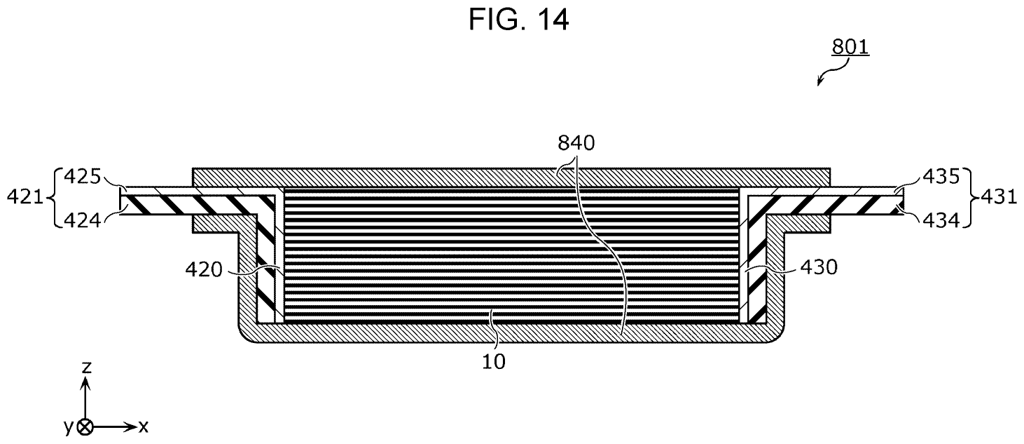

FIG. 14 is a cross-sectional view of a battery 801 according to the present embodiment.

As illustrated in FIG. 14, the battery 801 according to the present embodiment includes a power-generation element 10, an electrode connection member 420, a counter-electrode connection member 430, and an outer case 840. The power-generation element 10 is the same as that in Embodiment 5. The base material 421 of the electrode connection member 420 and the base material 431 of the counter-electrode connection member 430 are the same as those in Embodiment 5 except that the base materials 421 and 431 in the present embodiment are bent and then extend. In FIG. 14, illustration of the concrete layer structure of the power-generation element 10 is omitted. In addition, illustration of the conductive members 22 and 32 and the insulating members 23 and 33 is also omitted.

The outer case 840 contains the power-generation element 10. The outer case 840 is composed of, for example, two facing lamination films the outer peripheral portions of which are welded by thermocompression bonding. Alternatively, the outer case 840 may be one lamination film in the form of a bag.

As illustrated in FIG. 14, each of the base materials 421 and 431 extends to the outside of the outer case 840. The portion of the metal layer 425 of the base material 421 located outside the outer case 840 and the portion of the metal layer 435 of the base material 431 located outside the outer case 840 are used for electrical connection to another device or the like. In other words, the metal layers 425 and 435 function as output terminals of the battery 801.

In addition, lead terminals for outputting electrical current may be attached to the portions of the metal layers 425 and 435 exposed to the outside of the outer case 840.

In the battery 801 according to the present embodiment, the electrode connection member 420 and the counter-electrode connection member 430 located on the side surfaces 11 and 12, respectively, of the power-generation element 10 can serve as output electrodes. This improves the capacity density of the battery 801. In addition, enclosing the power-generation element 10 with the outer case 840 mitigates a deterioration of the power-generation element 10. This makes it possible to provide the battery 801 with high reliability.

Although the battery 801 in the present embodiment is an example of enclosing the power-generation element 10 of the battery 401 according to Embodiment 5 with the outer case 840, the present disclosure is not limited to this configuration. The battery 801 may be one enclosing the power-generation element 10 of the battery 501 according to Embodiment 6 or the battery 601 according to Embodiment 7 with the outer case 840.

Although the description in the present embodiment is based on an example in which the outer case 840 is composed of lamination films, the present disclosure is not limited to this configuration. The outer case 840 may be a metal can or the like.

### Embodiment 10

Next, the configuration of a battery according to Embodiment 10 will be described. In Embodiment 10, the positions of the electrode connection member and the counter-electrode connection member differ from those in Embodiment 1. The following description focuses on the differences from Embodiment 1, and description of common points is omitted or simplified.

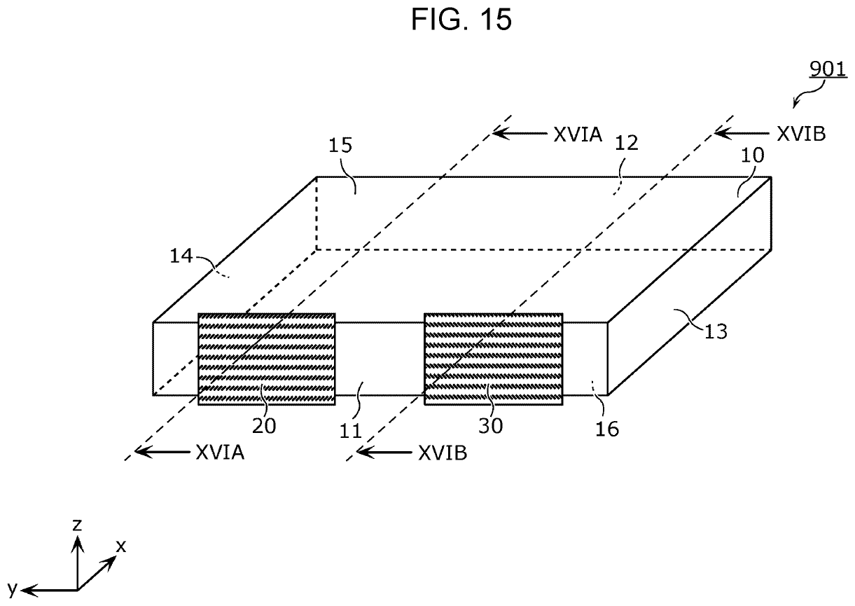

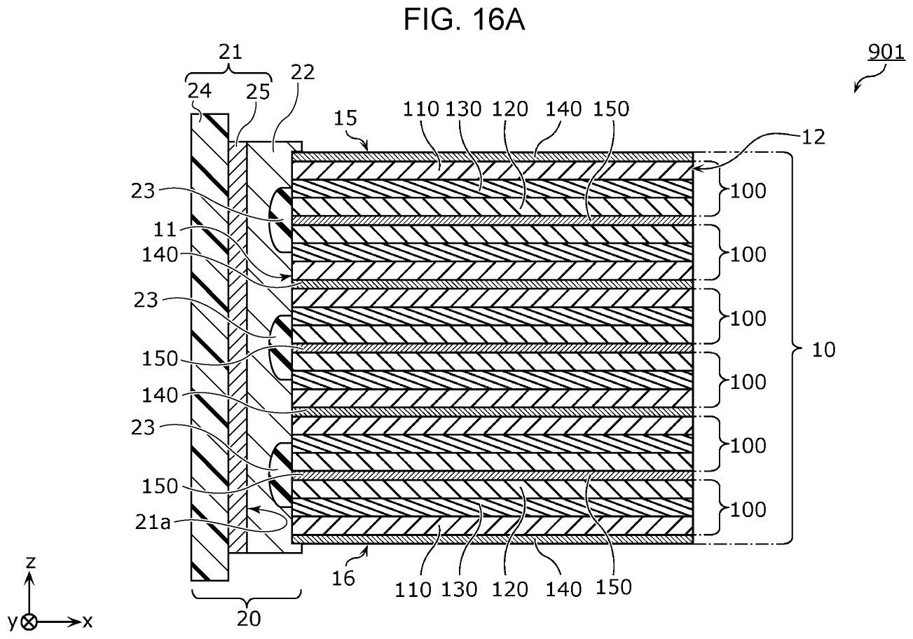

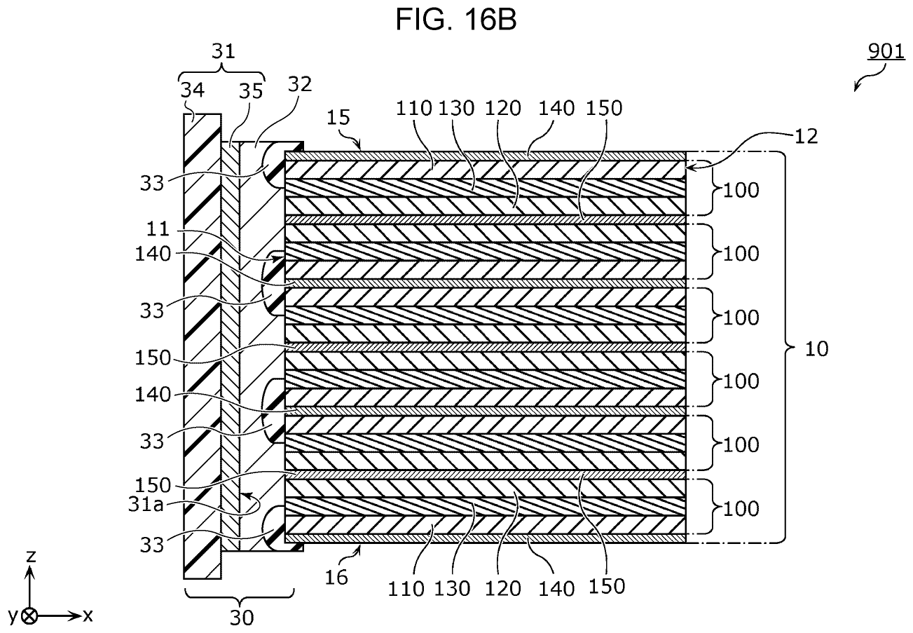

FIG. 15 is a perspective view of a battery 901 according to the present embodiment, illustrating its configuration. FIGS. 16A and 16B are cross-sectional views of the battery 901 according to the present embodiment. FIG. 16A is a cross-sectional view taken along line XVIA-XVIA in FIG. 15, in other words, FIG. 16A illustrates a cross section intersecting a first region of the side surface 11. FIG. 16B is a cross-sectional view taken along line XVIB-XVIB in FIG. 15, in other words, FIG. 16B illustrates a cross section intersecting a second region of the side surface 11.

As illustrated in FIGS. 15, 16A, and 16B, the battery 901 has an electrode connection member 20 and a counter-electrode connection member 30 connected to the same side surface 11. In other words, the side surface 11 includes the first region to which the electrode connection member 20 is connected and the second region to which the counter-electrode connection member 30 is connected. The first region and the second region are regions different from each other and do not overlap each other. The electrode connection member 20 and the counter-electrode connection member 30 are away from each other on the side surface 11.

Since the battery 901 according to the present embodiment enables the electrode connection member and the counter-electrode connection member to be in contact with and electrically connected to the side surface 11 of the power-generation element 10 to extend the electrodes, it is possible to increase the capacity density of the battery 901. In addition, since the electrode connection member 20 and the counter-electrode connection member 30 are gathered and placed on one side surface 11, the other side surfaces 12, 13, and 14 can be flat. This configuration enables the volume of portions not contributing to charging and discharging to be small, improving the effective volume of the battery 901. In addition, this configuration increases the case of mounting, for example, when the battery 901 is mounted on a substrate, and the degree of freedom in design, thereby increasing the degree of freedom in placing the battery 901 in electric or electronic devices.

Note that in the present embodiment, instead of the electrode connection member 20 and the counter-electrode connection member 30, the electrode connection member 220, 320, 420, 520, 620, or 720 and the counter-electrode connection member 230, 330, 430, 530, or 630 may be connected to the same side surface.

In addition, the electrode connection member 20 and the counter-electrode connection member 30 may have a common resin film as their base materials.

### Other Embodiments

Although the battery and the methods of manufacturing the battery according to the present disclosure have been described with reference to the embodiments, the present disclosure is not limited to these embodiments. Configurations made by modifying the embodiments in various manners that those skilled in the art can come up with and other configurations made by combining constituents in different embodiments are included in the scope of the present disclosure unless they depart from the spirit of the present disclosure.

For example, although the embodiments are based on examples in which a counter-electrode connection member 30 is connected to the side surface 11 or 12, the present disclosure is not limited to these configurations. A counter-electrode connection member 30 may be connected to the side surface 13 or 14. The number of electrode connection members 20 and the number of counter-electrode connection members 30 may also be two. For example, two electrode connection members 20 may be provided on the side surfaces 11 and 13, and two counter-electrode connection members 30 may be provided on the side surfaces 12 and 14. Alternatively, two electrode connection members 20 may be provided on the side surfaces 11 and 12, and two counter-electrode connection members 30 may be provided on the side surfaces 13 and 14.

For example, each of the side surfaces 11, 12, 13, and 14 may be inclined relative to the main surface 15 or 16. Each of the side surfaces 11, 12, 13, and 14 may be curved so as to protrude or be recessed or may include a plurality of flat surfaces having different inclination angles. For example, on the side surfaces 11, 12, 13, and 14, the end surfaces of the electrode layers 110, the counter-electrode layers 120, and the solid electrolyte layers 130 need not be flush with one another and may have protrusions and recesses.

In addition, for example, the number of battery cells 100 included in the power-generation element 10 may be two. In the case in which only two battery cells 100 are laminated such that the electrode layers 110 of the two battery cells 100 face each other, the number of electrode current collector layers 140 may be one. In the case in which only two battery cells 100 are laminated such that the counter-electrode layers 120 of the two battery cells 100 face each other, the number of counter-electrode current collector layers 150 may be one. As mentioned above, the number of electrode current collector layers 140 or counter-electrode current collector layers 150 included in the power-generation element 10 may be one. A configuration in which the power-generation element 10 does not include the electrode current collector layer 140 or the counter-electrode current collector layer 150 is possible.

For example, the number of battery cells 100 included in the power-generation element 10 may be either an even or odd number. In the case in which the number of battery cells 100 is an odd number, the polarities of the current collector layers located in the uppermost and lowermost layers are different. In this case, for example, the electrode connection member 20 can be connected to the main surface of the electrode current collector layer 140 in the uppermost layer, and the counter-electrode connection member 30 can be connected to the main surface of the counter-electrode current collector layer 150 in the lowermost layer.

For example, although the description of each embodiment is based on the battery in which the electrode connection member and the counter-electrode connection member have the same configuration or similar configurations, the present disclosure is not limited to these. For example, the battery may include one or more of the electrode connection members 20, 220, 320, 420, 520, 620, and 720 and one or more of the counter-electrode connection members 30, 230, 330, 430, 530, and 630.

For example, a configuration based on the battery according to one of the embodiments but without one of the electrode connection member and the counter-electrode connection member is possible. For example, a configuration in which a battery includes an electrode connection member and includes conductive lead parts for electrically connecting a plurality of counter-electrode layers 120 instead of a counter-electrode connection member is possible. Even in this case, the volume of the electrode extension portions is smaller than in the case in which lead parts are used in both the electrode and counter-electrode extension portions, and this improves the capacity density of the battery.

As for the aforementioned embodiments, various kinds of modification, replacement, addition, and omission can be made within the scope of the claims and the equivalents thereof.

The present disclosure can be used, for example, for the batteries of electronic devices, electric appliances and devices, electric vehicles, and the like.

What is claimed is:

1. A battery comprising:
a power-generation element including a plurality of laminated battery cells connected electrically in parallel, each battery cell including an electrode layer, a counter-electrode layer, and a solid electrolyte layer; and
a first connection member connected to a side surface of the power-generation element, wherein
the first connection member includes
a first base material having a first surface facing the side surface and
a first conductive member located on the first surface and electrically connected to the electrode layers, and
one or more first insulating members are located so as to cover the counter-electrode layers on the side surface.

2. The battery according to claim 1, further comprising
a second connection member connected to the side surface, wherein
the second connection member includes
a second base material having a second surface facing the side surface and
a second conductive member located on the second surface and electrically connected to the counter-electrode layers, and
one or more second insulating members are located so as to cover the electrode layers on the side surface.

3. The battery according to claim 2, wherein
the side surface includes a first side surface and a second side surface different from the first side surface,
the first connection member is connected to the first side surface,
the first surface faces the first side surface,
the second connection member is connected to the second side surface, and
the second surface faces the second side surface.

4. The battery according to claim 2, wherein
the side surface includes a first side surface including a first region and a second region different from the first region,
the first connection member is connected to the first region,
the first surface faces the first region,
the second connection member is connected to the second region, and
the second surface faces the second region.

5. The battery according to claim 1, wherein
the first base material includes a resin film.

6. The battery according to claim 5, wherein
the first base material further includes a metal layer located on a main surface of the resin film, and
the first surface is a surface of the metal layer opposite to the resin film.

7. The battery according to claim 6, wherein
the metal layer is connected to a main surface of an electrode layer located on a main surface of the power-generation element, out of the electrode layers of the plurality of battery cells.

8. The battery according to claim 1, wherein
the first base material is a metal foil.

9. The battery according to claim 8, wherein
the first base material is connected to a main surface of the power-generation element.

10. The battery according to claim 1, wherein
the first base material extends in a direction away from the side surface.

11. The battery according to claim 10, further comprising
an outer case containing the power-generation element, wherein
the first base material extends to an outside of the outer case.

12. The battery according to claim 3, wherein
the first side surface is flat.

13. The battery according to claim 1, wherein
the first conductive member contains a resin and conductive particles dispersed in the resin.

14. A method of manufacturing a battery, comprising
connecting a connection member to a side surface of a power-generation element including a plurality of laminated battery cells connected electrically in parallel, each battery cell including an electrode layer, a counter-electrode layer, and a solid electrolyte layer, wherein
the connection member includes
a base material having a first surface and
a conductive member located on the first surface, and
in the connecting the connection member, the conductive member is connected to the electrode layers such that the first surface faces the side surface, and that one or more insulating members are placed between the conductive member and the counter-electrode layers.

15. The method of manufacturing a battery according to claim 14, further comprising
forming the connection member, wherein
the forming the connection member includes
placing the conductive member on the first surface and
placing the one or more insulating members on a surface of the conductive member opposite to the base material at one or more specified positions.

16. The method of manufacturing a battery according to claim 14, further comprising
placing the one or more insulating members on the side surface of the power-generation element so as to cover the counter-electrode layers, wherein
the connecting the connection member is performed after the placing the one or more insulating members.

17. The method of manufacturing a battery according to claim 15, wherein
the placing the conductive member is performed by at least one of application or printing.

18. The method of manufacturing a battery according to claim 15, wherein
the placing the one or more insulating members is performed by printing.

19. The method of manufacturing a battery according to claim 14, wherein
the base material includes a resin film or a metal foil.

20. The method of manufacturing a battery according to claim 14, further comprising
forming the side surface including a cut surface by cutting the power-generation element in a direction intersecting a main surface of the power-generation element, wherein
in the connecting the connection member, the connection member is connected to the cut surface.
